(19) United States
(12) Patent Application Publication
(10) Pub. No.: US 2026/0095593 A1
(43) Pub. Date: Apr. 2, 2026

(54) MESH DECODING DEVICE, MESH ENCODING DEVICE, MESH DECODING METHOD, AND PROGRAM

(71) Applicant: KDDI CORPORATION, Tokyo (JP)

(72) Inventors: Jianfeng XU, Fujimino-shi (JP); Kei KAWAMURA, Fujimino-shi (JP)

(73) Assignee: KDDI CORPORATION, Tokyo (JP)

(21) Appl. No.: 19/414,342

(22) Filed: Dec. 10, 2025

Related U.S. Application Data
(63) Continuation of application No. PCT/JP2024/008388, filed on Mar. 5, 2024.

(30) Foreign Application Priority Data
Jul. 6, 2023 (JP) 2023-111753

(51) Int. Cl. H04N 19/597; H04N 19/137; H04N 19/17; H04N 19/70

(52) U.S. Cl. CPC H04N 19/597; H04N 19/137; H04N 19/17; H04N 19/70

(57) ABSTRACT

In a mesh decoding device according to the present invention, in a mode 1, the motion vector calculation unit outputs the motion vector of the vertex to be decoded by adding the motion vector residual and the motion vector predicted value, in a mode 0, the motion vector calculation unit outputs the motion vector residual as the motion vector of the vertex to be decoded, the motion vector calculation unit sets the same mode for motion vectors of N (N≥1) consecutive vertices in a decoding order, the N vertices are included in one group, and the motion vector calculation unit decodes, from a bit stream, a control signal for calculating a group size indicating a size of the group.

### CROSS-REFERENCE TO RELATED APPLICATIONS

The present application is a continuation of PCT Application No. PCT/JP2024/008388, filed on Mar. 5, 2024, which claims the benefit of Japanese patent application No. 2023-111753 filed on Jul. 6, 2023, the entire contents of each application being incorporated herein by reference in its entirety.

### TECHNICAL FIELD

The present invention relates to a mesh decoding device, a mesh encoding device, a mesh decoding method, and a program.

### BACKGROUND ART

Non Patent Literature 1 (Khaled Mammou, Jungsun Kim, Alexis M Tourapis, Dimitri Podborski, and Krasimir Kolarov, “[V-CG] Apple's Dynamic Mesh Coding CfP Response,” April 2022, ISO/IEC JTC 1/SC 29/WG 7 m59281) discloses a technology for encoding a mesh using Non Patent Literature 2 (Google Draco, accessed on May 26, 2022, [Online], https://google.github.io/draco) or Non Patent Literature 3 (Jean-Eudes Marvie, Olivier Mocquard, “[V-DMC] [EE4.4-related] An efficient EdgeBreaker implementation,” April 2023, ISO/IEC JTC 1/SC 29/WG 7 m63344).

### SUMMARY OF THE INVENTION

However, the related art has a problem that the encoding efficiency of the motion vector is low. Therefore, the present invention has been made in view of the above-described problems, and an object of the present invention is to provide a mesh decoding device, a mesh decoding method, and a program capable of improving mesh encoding efficiency.

The first aspect of the present invention is summarized as a mesh decoding device including: a motion vector residual decoding unit that generates a motion vector residual from a bit stream of an inter frame; a motion vector prediction unit that acquires decoded motion vectors from a vertex to be decoded and surrounding vertices connected to the vertex to be decoded, and outputs a motion vector predicted value of the vertex to be decoded using all or some of the decoded motion vectors; and a motion vector calculation unit that outputs a motion vector of the vertex to be decoded, wherein in a mode 1, the motion vector calculation unit outputs the motion vector of the vertex to be decoded by adding the motion vector residual and the motion vector predicted value, in a mode 0, the motion vector calculation unit outputs the motion vector residual as the motion vector of the vertex to be decoded, the motion vector calculation unit sets the same mode for motion vectors of N (N≥1) consecutive vertices in a decoding order, the N vertices are included in one group, and the motion vector calculation unit decodes, from a bit stream, a control signal for calculating a group size indicating a size of the group.

The second aspect of the present invention is summarized as a mesh decoding method including: a step A of generating a motion vector residual from a bit stream of an inter frame; a step B of acquiring decoded motion vectors from a vertex to be decoded and surrounding vertices connected to the vertex to be decoded, and outputting a motion vector predicted value of the vertex to be decoded using all or some of the decoded motion vectors; and a step C of outputting a motion vector of the vertex to be decoded, wherein in the step C, in a mode 1, the motion vector of the vertex to be decoded is output by adding the motion vector residual and the motion vector predicted value, in a mode 0, the motion vector residual is output as the motion vector of the vertex to be decoded, the same mode is set for motion vectors of N (N≥1) consecutive vertices in a decoding order, the N vertices are included in one group, and a control signal is decoded from a bit stream, the control signal being a signal for calculating a group size indicating a size of the group.

The third aspect of the present invention is summarized as a non-transitory computer-readable medium having stored thereon a program that is executable by a computer to cause the computer to function as a mesh decoding device, the mesh decoding device including: a motion vector residual decoding unit that generates a motion vector residual from a bit stream of an inter frame; a motion vector prediction unit that acquires decoded motion vectors from a vertex to be decoded and surrounding vertices connected to the vertex to be decoded, and outputs a motion vector predicted value of the vertex to be decoded using all or some of the decoded motion vectors; and a motion vector calculation unit that outputs a motion vector of the vertex to be decoded, wherein in a mode 1, the motion vector calculation unit outputs the motion vector of the vertex to be decoded by adding the motion vector residual and the motion vector predicted value, in a mode 0, the motion vector calculation unit outputs the motion vector residual as the motion vector of the vertex to be decoded, the motion vector calculation unit sets the same mode for motion vectors of N (N≥1) consecutive vertices in a decoding order, the N vertices are included in one group, and the motion vector calculation unit decodes, from a bit stream, a control signal for calculating a group size indicating a size of the group.

According to the present invention, it is possible to provide a mesh decoding device, a mesh encoding device, a mesh decoding method, and a program capable of improving mesh encoding efficiency.

### BRIEF DESCRIPTION OF THE DRAWINGS

FIG. 1 is a diagram illustrating an example of a configuration of a mesh processing system 1 according to an embodiment.

FIG. 2 is a diagram illustrating an example of functional blocks of a mesh decoding device 200 according to an embodiment.

FIG. 3A is a diagram illustrating an example of a base mesh and a subdivided mesh.

FIG. 3B is a diagram illustrating an example of the base mesh and the subdivided mesh.

FIG. 4 is a diagram illustrating an example of a syntax configuration of a base mesh bit stream.

FIG. 5 is a diagram illustrating an example of a syntax configuration of a base patch header (BPH).

FIG. 6 is a diagram illustrating an example of functional blocks of a base mesh decoding unit 202 of the mesh decoding device 200 according to an embodiment.

FIG. 7 is a diagram illustrating an example of functional blocks of an intra decoding unit 202B of the base mesh decoding unit 202 of the mesh decoding device 200 according to an embodiment.

FIG. 8 is a flowchart illustrating an example of an operation of the arrangement unit 202B2 of the intra decoding unit 202B of the base mesh decoding unit 202 of the mesh decoding device 200 according to an embodiment.

FIG. 9 is a diagram for describing an example of an operation of the arrangement unit 202B2 of the intra decoding unit 202B of the base mesh decoding unit 202 of the mesh decoding device 200 according to an embodiment.

FIG. 10A is a diagram illustrating an example of a decoding order of a mesh.

FIG. 10B illustrates an example of a list of vertices around a vertex to be decoded.

FIG. 11 is a diagram illustrating an example of statistical data indicating a relationship between the number of decoded motion vectors and the number of vertices around a vertex to be decoded.

FIG. 12 is a diagram for describing an example of a worst case.

FIG. 13 is a diagram for describing the modification example 2 of the inter decoding unit 202E of the base mesh decoding unit 202 of the mesh decoding device 200 according to an embodiment.

FIG. 14 is a diagram for describing the modification example 2 of the inter decoding unit 202E of the base mesh decoding unit 202 of the mesh decoding device 200 according to the embodiment.

FIG. 15 is a diagram illustrating a modification example of functional blocks of the modification example 1 of the base mesh decoding unit 202 of the mesh decoding device 200 according to an embodiment.

FIG. 16 is a diagram for describing the modification example 1 of the base mesh decoding unit 202 of the mesh decoding device 200 according to an embodiment.

FIG. 17 is a diagram for describing a mesh buffer unit 202C of the base mesh decoding unit 202 of the mesh decoding device 200 according to an embodiment.

FIG. 18 is a diagram for describing the mesh buffer unit 202C of the base mesh decoding unit 202 of the mesh decoding device 200 according to an embodiment.

FIG. 19 is a diagram for describing a modification example of the base mesh decoding unit 202 of the mesh decoding device 200 according to the modification example 2.

FIG. 20 is a diagram for describing a modification example of the base mesh decoding unit 202 of the mesh decoding device 200 according to the modification example 2.

FIG. 21 is a diagram illustrating an example of functional blocks of a subdivision unit 203 of the mesh decoding device 200 according to an embodiment.

FIG. 22 is a diagram illustrating an example of functional blocks of a base mesh subdivision unit 203A of the subdivision unit 203 of the mesh decoding device 200 according to an embodiment.

FIG. 23 is a diagram for describing an example of a method of dividing a base face by a base face division unit 203A5 of the base mesh subdivision unit 203A of the subdivision unit 203 of the mesh decoding device 200 according to an embodiment.

FIG. 24 is a flowchart illustrating an example of an operation of the base mesh subdivision unit 203A of the subdivision unit 203 of the mesh decoding device 200 according to an embodiment.

FIG. 25 is a diagram illustrating an example of functional blocks of a subdivided mesh adjustment unit 203B of the subdivision unit 203 of the mesh decoding device 200 according to an embodiment.

FIG. 26 is a diagram illustrating an example of a case where an edge division point on a base face ABC is moved by an edge division point moving unit 701 of the subdivided mesh adjustment unit 203B of the subdivision unit 203 of the mesh decoding device 200 according to an embodiment.

FIG. 27 is a diagram illustrating an example of a case where a subdivided face X in the base face is subdivided again by a subdivided face division unit 702 of the subdivided mesh adjustment unit 203B of the subdivision unit 203 of the mesh decoding device 200 according to an embodiment.

FIG. 28 is a diagram illustrating an example of a case where all the subdivided faces are subdivided again by the subdivided face division unit 702 of the subdivided mesh adjustment unit 203B of the subdivision unit 203 of the mesh decoding device 200 according to an embodiment.

FIG. 29 is a diagram illustrating an example of functional blocks of a displacement decoding unit 206 of the mesh decoding device 200 according to an embodiment (in a case where inter-prediction is performed in a spatial domain).

FIG. 30 is a diagram illustrating an example of a configuration of a displacement bit stream.

FIG. 31 is a diagram illustrating an example of a syntax configuration of a DPS.

FIG. 32 is a diagram illustrating an example of a syntax configuration of a DPH.

FIG. 33 is a diagram for describing an example of a correspondence of frequencies between a reference frame and a frame to be decoded in a case where inter prediction is performed in a spatial domain.

FIG. 34 is a diagram illustrating an example of functional blocks of a displacement decoding unit 206 of the mesh decoding device 200 according to an embodiment (in a case where inter-prediction is performed in a frequency domain).

FIG. 35 is a diagram for describing an example of a correspondence of frequencies between a reference frame and a frame to be decoded in a case where inter-prediction is performed in a frequency domain.

FIG. 36 is a flowchart illustrating an example of an operation of the displacement decoding unit 206 of the mesh decoding device 200 according to an embodiment.

FIG. 37 is a diagram illustrating an example of functional blocks of a displacement decoding unit 206 according to the modification example 1.

FIG. 38 is a diagram illustrating an example of functional blocks of a displacement decoding unit 206 according to the modification example 2.

FIG. 39 is a diagram illustrating an example of a NAL header.

### DESCRIPTION OF EMBODIMENTS

An embodiment of the present invention will be described hereinbelow with reference to the drawings. Note that the constituent elements of the embodiment below can, where appropriate, be substituted with existing constituent elements and the like, and that a wide range of variations, including combinations with other existing constituent elements, is possible. Therefore, there are no limitations placed on the content of the invention as in the claims on the basis of the disclosures of the embodiment hereinbelow.

### First Embodiment

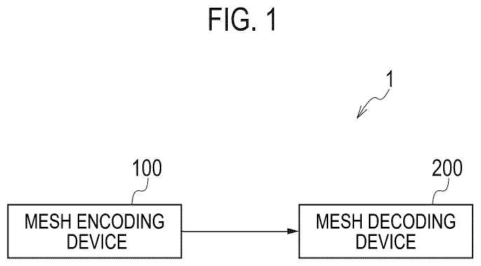

Hereinafter, a mesh processing system according to the present embodiment will be described with reference to FIGS. 1 to 38.

FIG. 1 is a diagram illustrating an example of a configuration of a mesh processing system 1 according to the present embodiment. As illustrated in FIG. 1, the mesh processing system 1 includes a mesh encoding device 100 and a mesh decoding device 200.

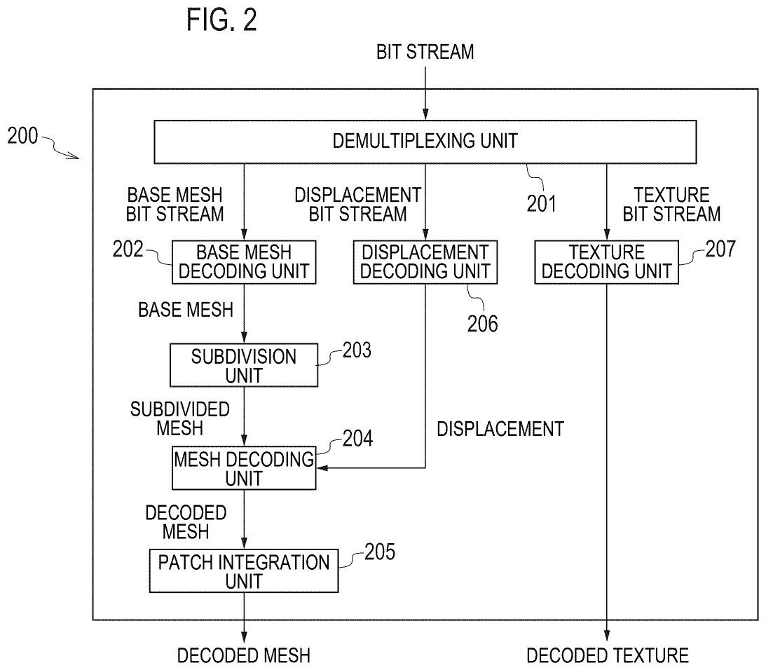

FIG. 2 is a diagram illustrating an example of functional blocks of the mesh decoding device 200 according to the present embodiment.

As illustrated in FIG. 2, the mesh decoding device 200 includes a demultiplexing unit 201, a base mesh decoding unit 202, a subdivision unit 203, a mesh decoding unit 204, a patch integration unit 205, a displacement decoding unit 206, and a video decoding unit 207.

Here, the base mesh decoding unit 202, the subdivision unit 203, the mesh decoding unit 204, and the displacement decoding unit 206 may be configured to perform processing in units of patches obtained by dividing a mesh, and the patch integration unit 205 may be configured to integrate the processing results thereafter.

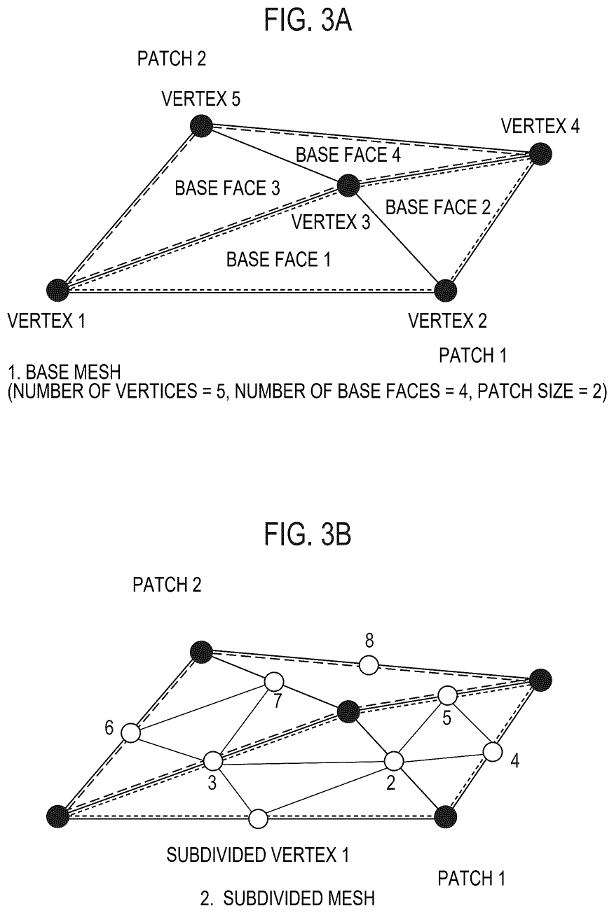

In the example of FIG. 3A, the mesh is divided into a patch 1 having base faces 1 and 2 and a patch 2 having base faces 3 and 4.

The demultiplexing unit 201 is configured to separate a multiplexed bit stream into a base mesh bit stream, a displacement bit stream, and a texture bit stream.

### <Base Mesh Decoding Unit 202>

The base mesh decoding unit 202 is configured to decode the base mesh bit stream, and generate and output a base mesh.

Here, the base mesh includes a plurality of vertices in a three-dimensional space and edges connecting the plurality of vertices.

As illustrated in FIG. 3A, the base mesh is configured by combining base faces expressed by three vertices.

The base mesh decoding unit 202 may be configured to decode the base mesh bit stream using, for example, Draco described in Non Patent Literature 2 or the technology described in Non Patent Literature 3.

Furthermore, the base mesh decoding unit 202 may be configured to generate “subdivision method id” described below as control information for controlling a type of a subdivision method.

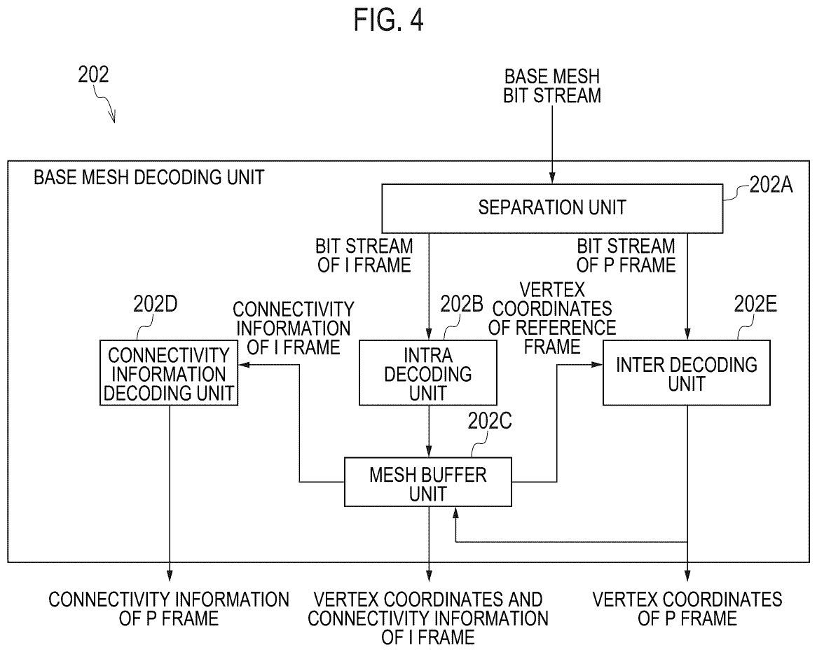

As illustrated in FIG. 4, the base mesh decoding unit 202 includes a separation unit 202A, an intra decoding unit 202B, a mesh buffer unit 202C, a connectivity information decoding unit 202D, and an inter decoding unit 202E.

The separation unit 202A is configured to classify the base mesh bit stream into an I-frame bit stream and a P-frame bit stream.

### (Intra Decoding Unit 202B)

The intra decoding unit 202B is configured to decode coordinates and connectivity information of vertices of an I frame from the I-frame bit stream using, for example, Draco described in Non Patent Literature 2 or the technology described in Non Patent Literature 3.

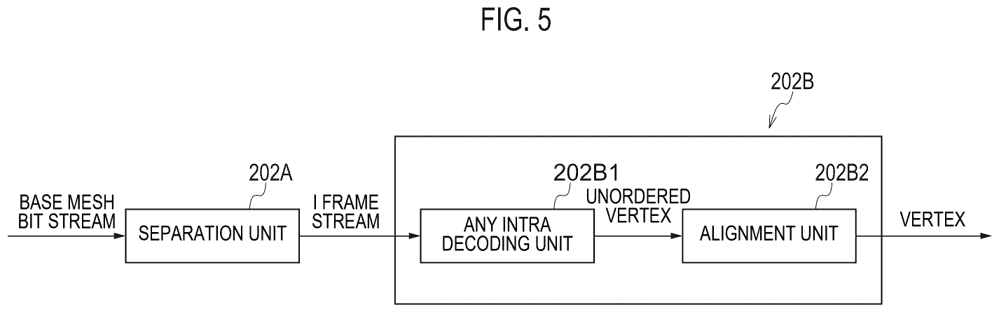

FIG. 5 is a diagram illustrating an example of functional blocks of the intra decoding unit 202B.

As illustrated in FIG. 5, the intra decoding unit 202B includes an any intra decoding unit 202B1 and an alignment unit 202B2.

The any intra decoding unit 202B1 is configured to decode the coordinates and the connectivity information of the unordered vertex of the I frame from the bit stream of the I frame using any method including Draco described in Non Patent Literature 2 or the technology described in Non Patent Literature 3.

The alignment unit 202B2 is configured to output the vertices by rearranging the unordered vertices in a predetermined order.

As the predetermined order, for example, a Morton code order may be used, or a raster scan order may be used.

Furthermore, the alignment unit 202B2 may collectively set duplicate vertices that are a plurality of vertices having identical coordinates in the decoded base mesh as a single vertex, and then rearranges the vertices in a predetermined order.

The mesh buffer unit 202C is configured to accumulate coordinates and connectivity information of vertices of the I frame decoded by the intra decoding unit 202B. Here, a specific buffer that stores a pair of indexes A (k) and B (k) of vertices existing as duplicate vertices in a predetermined order may be provided.

The connectivity information decoding unit 202D is configured to set the connectivity information of the I frame extracted from mesh buffer unit 202C as the connectivity information of the P frame.

The inter decoding unit 202E is configured to decode the coordinates of the vertices of the P frame by adding the coordinates of the vertices of the I frame extracted from the mesh buffer unit 202C and the motion vector decoded from the bit stream of the P frame.

Furthermore, the inter decoding unit 202E can adjust the index of the vertex of the P frame by the pair of indices A (k) and B (k) of the vertices existing as the duplicate vertices stored in the specific buffer.

Here, all or some of the indexes described above are decoded from the bit stream. Such a decoding method may be arithmetic encoding. As a result, an effect that the maximum value of the index to be decoded using the arithmetic encoding is not limited can be expected.

For example, the arithmetic encoding of ue(v) may be used. ue(v) indicates exponential-Golomb encoding (Exp-Golomb) of an unsigned integer 0-order with a first left bit.

Specifically, the interpretation process of the syntax element of ue(v) starts from the current position in the bit stream, and starts by reading bits including the first non-zero bit and counting the number of preceding bits equal to 0. The process is designated as follows:

$$leadingZeroBits = - 1$$

$$for ( b = 0 ; ! b ; leadingZeroBits ++$$

$$b = read\_bits ( 1 )$$

The variable codeNum is then assigned as follows:
codeNum=2^{leadingZeroBits}−1+read bits (leadingZeroBits)

However, the value returned by read bits (leadingZeroBits) is interpreted as a binary representation of the unsigned integer the most significant bit of which was previously written. Also, the value of ue(v) is equal to the value of codeNum.

Table 1 illustrates the structure of the Exp-Golomb code, separating the bit string into a “prefix” bit and a “suffix” bit.

TABLE 1

| BIT STRING | CodeNum RANGE |
|---|---|
| 1 | 0 |
| 01x₀ | 1 . . . 2 |
| 001x₁x₀ | 3 . . . 6 |
| 0001x₂x₁x₀ | 7 . . . 14 |
| 00001x₃x₂x₁x₀ | 15 . . . 30 |
| 000001x₄x₃x₂x₁x₀ | 31 . . . 62 |
| . . . | . . . |

Here, the “prefix” bit is a bit that is interpreted as being designated in the calculation of leadingZeroBits, and is indicated as 0 or 1 in the bit string in Table 1.

The “suffix” bit is a bit interpreted in the calculation of codeNum and is indicated as xi in Table 1. i ranges from 0 to leadingZeroBits−1. Each xi is equal to either 0 or 1.

Table 2 illustrates how to explicitly assign a bit string to the value of codeNum. Here, the value of ue(v) is equal to the value of codeNum.

TABLE 2

| BIT STRING | codeNum |
|---|---|
| 1 | 0 |
| 010 | 1 |
| 011 | 2 |
| 00100 | 3 |
| 00101 | 4 |
| 00110 | 5 |
| 00111 | 6 |
| 0001000 | 7 |
| 0001001 | 8 |
| 0001010 | 9 |
| . . . | . . . |

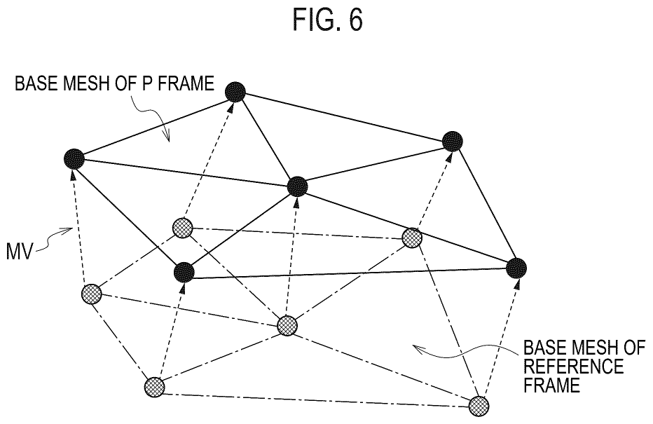

In the present embodiment, as illustrated in FIG. 6, there is a correspondence between the vertices of the base mesh of the P frame and the vertices of the base mesh of the reference frame (I frame or P frame). Here, the motion vector decoded by the inter decoding unit 202E is a difference vector between the coordinates of the vertex of the base mesh of the P frame and the coordinates of the vertex of the base mesh of the I frame.

### (Inter Decoding Unit 202E)

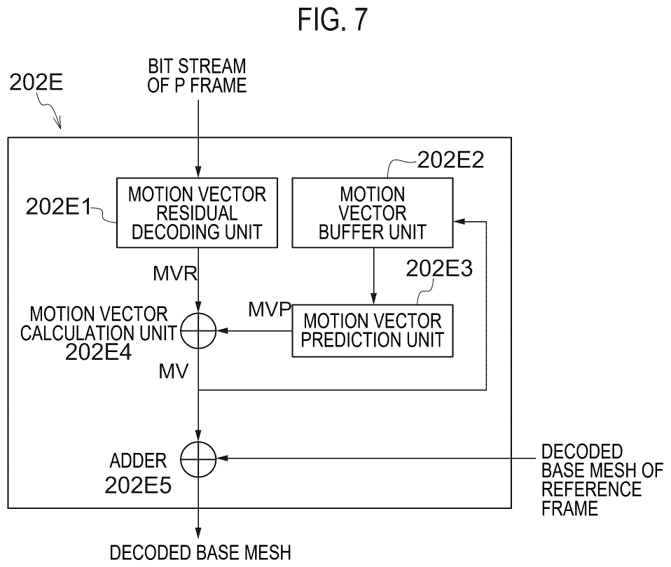

FIG. 7 is a diagram illustrating an example of functional blocks of the inter decoding unit 202E.

As illustrated in FIG. 7, the inter decoding unit 202E includes a motion vector residual decoding unit 202E1, a motion vector buffer unit 202E2, a motion vector prediction unit 202E3, a motion vector calculation unit 202E4, and an adder 202E5.

The motion vector residual decoding unit 202E1 is configured to generate a motion vector residual (MVR) from a P frame bit stream.

Here, the MVR is a motion vector residual indicating a difference between a motion vector (MV) and a motion vector prediction (MVP). The MV is a difference vector (motion vector) between the coordinates of the vertex of the corresponding I frame and the coordinates of the vertex of the P frame. The MVP is a predicted value of the MV of a target vertex using the MV (a predicted value of a motion vector).

The motion vector buffer unit 202E2 is configured to sequentially store the MVs output by the motion vector calculation unit 202E4.

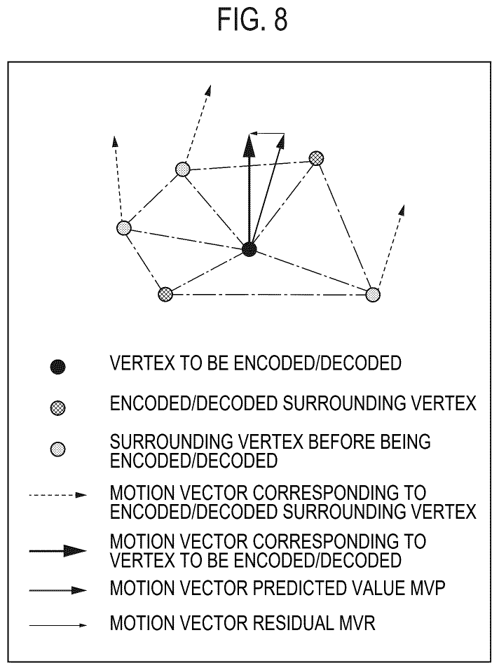

The motion vector prediction unit 202E3 is configured to acquire the decoded MV from the motion vector buffer unit 202E2 for the vertex connected to the vertex to be decoded, and output the MVP of the vertex to be decoded using all or some of the acquired decoded MVs as illustrated in FIG. 8.

The motion vector calculation unit 202E4 is configured to add the MVR generated by the motion vector residual decoding unit 202E1 and the MVP output from the motion vector prediction unit 202E3, and output the MV of the vertex to be decoded.

The adder 202E5 is configured to add the coordinates of the vertex corresponding to the vertex to be decoded obtained from the decoded base mesh of the reference frame (I frame or P frame) having the correspondence and the motion vector MV output from the motion vector calculation unit 202E3, and output the coordinates of the vertex to be decoded.

Details of each unit of the inter decoding unit 202E will be described below.

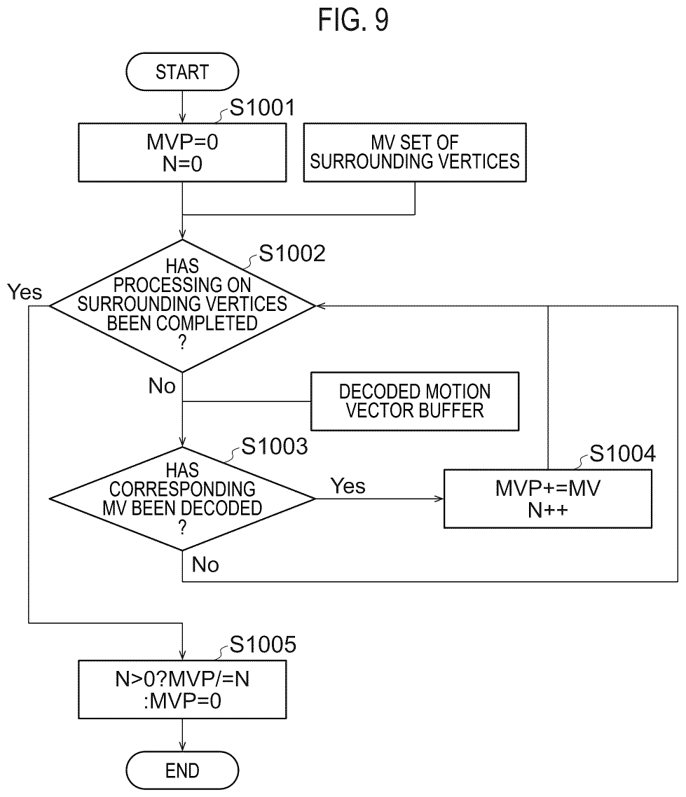

FIG. 9 is a flowchart illustrating an example of the operation of the motion vector prediction unit 202E3. Hereinafter, the operation of the motion vector prediction unit 202E3 will be referred to as an “average prediction method”.

As illustrated in FIG. 9, in step S1001, the motion vector prediction unit 202E3 sets the MVP and N to 0.

In step S1002, the motion vector prediction unit 202E3 acquires a set of MVs of vertices around the vertex to be decoded from the motion vector buffer unit 202E2, identifies a vertex for which subsequent processing has not been completed, and transitions to No. In a case where the subsequent processing has been completed for all vertices, the motion vector prediction unit 202E3 transitions to Yes.

In step S1003, the motion vector prediction unit 202E3 transitions to No when the MV of the vertex to be processed has not been decoded, and transitions to Yes if the MV of the vertex to be processed has been decoded.

In step S1004, the motion vector prediction unit 202E3 adds the MV to the MVP and adds 1 to N.

In step S1005, the motion vector prediction unit 202E3 outputs a result obtained by dividing the MVP by N when N is larger than 0, outputs 0 when N is 0, and ends the process.

That is, the motion vector prediction unit 202E3 is configured to output the MVP to be decoded by averaging the decoded motion vectors of the vertices around the vertex to be decoded.

Note that the motion vector prediction unit 202E3 may be configured to set the MVP to 0 in a case where the set of decoded motion vectors is an empty set.

The motion vector calculation unit 202E4 may be configured to calculate the MV of the vertex to be decoded from the MVP output by the motion vector prediction unit 202E3 and the MVR generated by the motion vector residual decoding unit 202E1 according to Expression (1).

$$MV ( k ) = MVP ( k ) + MVR ( k ) \qquad ( 1 )$$

Here, k is an index of a vertex. MV, MVR, and MVP are vectors having an x component, a y component, and a z component.

According to such a configuration, since only the MVR is encoded instead of the MV using the MVP, it is possible to expect an effect of increasing the encoding efficiency.

The adder 202E5 is configured to calculate the coordinates of the vertex by adding the MV of the vertex calculated by the motion vector calculation unit 202E4 and the coordinates of the vertex of the reference frame corresponding to the vertex, and keep the connectivity information (Connectivity) as a reference frame.

Specifically, the adder 202E5 may be configured to calculate the coordinate v′ᵢ(k) of the k-th vertex using Expression (2).

$${v}_{i}^{′} ( k ) = {v}_{j}^{′} ( k ) + MV ( k ) \qquad ( 2 )$$

Here, v′ᵢ(k) is a coordinate of a k-th vertex to be decoded in the frame to be decoded, v′ⱼ(k) is a coordinate of a decoded k-th vertex of the reference frame, MV(k) is a k-th MV of the frame to be decoded, and k=1, 2, . . . , K.

Further, the connectivity information of the frame to be decoded is made a same as the connectivity information of the reference frame.

Note that, since the motion vector prediction unit 202E3 calculates the MVP using the decoded MV, the decoding order affects the MVP.

The decoding order is the decoding order of the vertices of the base mesh of the reference frame. In general, in the case of a decoding method in which the number of base faces is increased one by one from an edge serving as a starting point using a constant repetition pattern, the order of vertices of the decoded base mesh is determined in the process of decoding.

For example, the motion vector prediction unit 202E3 may determine the decoding order of the vertices using Edgebreaker in the base mesh of the reference frame.

According to such a configuration, since the MV from the reference frame is encoded instead of the coordinates of the vertex, it is possible to expect an effect of increasing the encoding efficiency.

### Modification Example 1 of Inter Decoding Unit 202E

Hereinafter, Modification Example 1 of the inter decoding unit 202E will be described.

In the “average prediction method” of averaging decoded motion vectors of vertices around a vertex to be decoded, the motion vector prediction unit 202E3 of the inter decoding unit 202E calculates the MVP using all or only some of the decoded motion vectors of the vertices around the vertex to be decoded so as not to exceed a maximum usage number determined in advance.

Note that the maximum usage number determined in advance is decoded from the bit stream as a control signal.

Furthermore, in a case where the number of decoded motion vectors of vertices around the vertex to be decoded exceeds the maximum usage number, the motion vector prediction unit 202E3 picks up motion vectors up to the maximum usage number according to a certain rule.

For example, the motion vector prediction unit 202E3 selects the first or last vertex in the decoding order as such a rule.

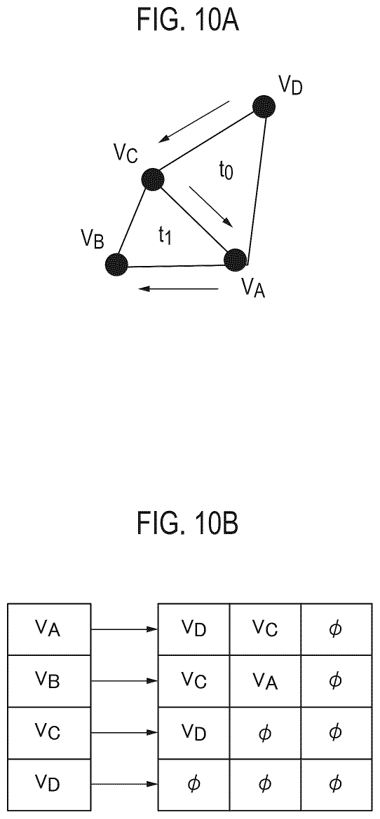

The decoding order for the mesh as illustrated in FIG. 10A is vertices v_{D→}c_{c→}v_{A→}v_{B} as indicated by arrows.

FIG. 10B is a list of vertices around the vertex to be decoded used when the MVP of each of the vertices v_{A} to v_{D} is calculated when the maximum value of the number of decoded neighboring vertices is set to 3.

According to such a configuration, by determining the maximum number of neighboring vertices, an effect of reducing the calculation amount and the memory amount while maintaining or slightly reducing the encoding efficiency can be expected.

However, in order to exhibit the above-described effect, it is necessary to set an appropriate maximum number of neighboring vertices in the mesh encoding device 100 and write the maximum number of neighboring vertices in the bit stream as an associated control signal.

Therefore, since the memory amount prepared by the mesh decoding device 200 is determined in the range that can be set as the maximum number of neighboring vertices described above, encoding/decoding is performed so that the maximum number of neighboring vertices becomes equal to or less than a preset maximum value as a reasonable constraint regarding the maximum number of neighboring vertices.

As described above, by defining a reasonable constraint regarding the maximum number of neighboring vertices, an effect of facilitating the design of the mesh decoding device 200 can be expected.

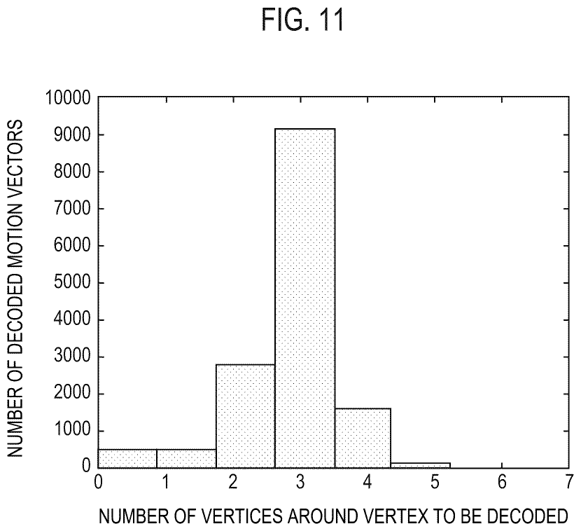

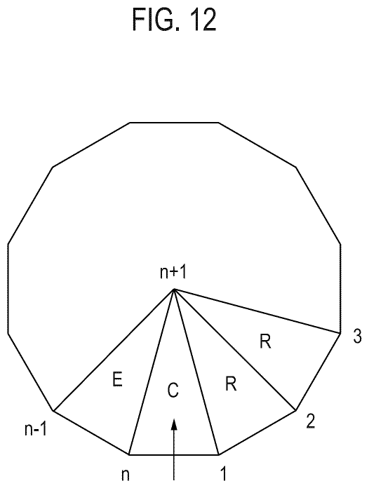

In general, the average of the number of neighboring vertices in the Closed 2-manifold triangle mesh is about six, but statistically, the maximum number of neighboring vertices is often seven to eight. As illustrated in FIG. 11, the number of decoded motion vectors (vertical axis) dynamically changes according to the number of vertices around the vertex to be decoded (horizontal axis).

Therefore, it is desirable to narrow the range that can be set as the maximum number of neighboring vertices described above.

For example, as illustrated in FIG. 11, the effect of reducing the calculation amount and the memory amount can be exerted by including “three”, which is the number of vertices around the vertex to be decoded having the largest number of decoded motion vectors statistically, within the range that can be set as the maximum number of neighboring vertices in the control signal described above, or by setting a value that is not larger than a natural number that can be covered up to a certain ratio (for example, 50% or 120%) or N bits (for example, 3 bits) of the average of the statistical number of neighboring vertices to the upper limit (maximum value) of the range that can be set as the maximum number of neighboring vertices in the control signal described above.

On the other hand, if the range that can be set as the maximum number of neighboring vertices is set to a large value, for example, 256 or 8 bits in the worst case, there is a possibility that the effect of reducing not only the memory amount but also the calculation amount cannot be exhibited.

FIG. 12 illustrates an example of a worst case, and when n≥256, the number of decoded neighboring vertices exceeds 256. In FIG. 12, the number of decoded neighboring vertices at the vertex n+1 is n.

In a case where the upper limit of the maximum number of neighboring vertices is set to 256, the mesh decoding device 200 requires not only a large memory but also a large calculation amount as illustrated in FIG. 10B. Therefore, the upper limit (maximum value) of the range that can be set as the maximum number of neighboring vertices described above may be 8.

The range that can be set as the maximum number of neighboring vertices in the above-described control signal may be a clear value, or may be calculated from other control signals or data.

For example, a range that can be set as the maximum number of neighboring vertices in the control signal may be defined by Level1.

Alternatively, the upper limit of the range that can be set as the maximum number of neighboring vertices in the control signal may be calculated from the number of vertices of the base mesh according to the following Expression (3).

$$Upper limit of range that can be set as maximum number of neighboring vertices in control signal = log 2 ( number of vertices of base mesh ) \qquad Expression ( 3 )$$

According to such a configuration, a settable range of the maximum number of neighboring vertices can be appropriately determined, and an effect of reliably reducing both the calculation amount and the memory amount can be expected even in the worst case.

### Modification Example 2 of Inter Decoding Unit 202E

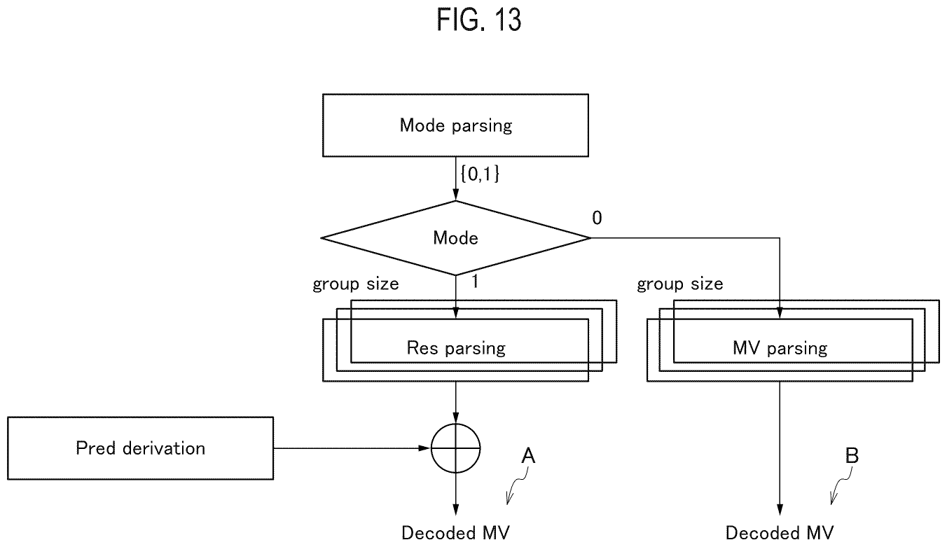

Hereinafter, Modification Example 2 of the inter decoding unit 202E will be described with reference to FIG. 13.

The motion vector calculation unit 202E4 of the inter decoding unit 202E has the mode 1 and the mode 0.

In the mode 1, the motion vector calculation unit 202E4 adds the MVR generated by the motion vector residual decoding unit 202E1 and the MVP output from the motion vector prediction unit 202E3, and outputs an MV of the vertex to be decoded (see A of FIG. 13).

On the other hand, in the mode 0, the motion vector calculation unit 202E4 outputs the MVR generated by the motion vector residual decoding unit 202E1 as an MV of the vertex to be decoded (see B of FIG. 13).

Note that the operation of the motion vector calculation unit 202E4 in the mode 0 corresponds to an operation of setting the MVP output from the motion vector prediction unit 202E3 to 0.

The motion vector calculation unit 202E4 may make the modes of MVs of N (N≥1) consecutive vertices the same in the decoding order.

The motion vector calculation unit 202E4 groups the above-described N vertices into one group. Such a size (group size) N of the group is 1 or more. The motion vector calculation unit 202E4 decodes a control signal (group size illustrated in FIG. 13) for calculating such a group size from the bit stream.

However, in a case where the number of vertices remaining in the last group is smaller than the group size, the motion vector calculation unit 202E4 puts all the remaining vertices into the group.

As described above, when the consecutive N vertices are set to the same mode, the code amount of the mode can be reduced, so that the effect of improving the encoding efficiency can be expected.

Here, as the number of consecutive vertices having the same mode increases, the effect of reducing the code amount of the mode increases. Therefore, it is necessary to set an appropriate group size in the mesh encoding device 100 and decode the group size from the bit stream as a control signal in the mesh decoding device 200.

Therefore, it is desirable that the settable range in such a control signal is not smaller than the number of consecutive vertices having the same mode in practice.

For example, in a case where almost the same mode is selected for all vertices, the group size may be set to the total number of vertices.

Table 1 illustrates examples of a case where the number of vertices for which the mode 0 is selected is 80% or more and a case where the number of vertices for which the mode 1 is selected is 90% or more.

Therefore, a settable range in the control signal is set to cover values from 1 to a preset maximum value. The maximum value is equal to or larger than the total number of vertices of the base mesh.

TABLE 3

| NAME OF | AVERAGE NUMBER | | |
|---|---|---|---|
| SEQUENCE | OF VERTICES | MODE 0 | MODE 1 |
| s8c2r1-levi | 649.96 | 2.20% | 97.80% |
| s8c2r2-levi | 2445.88 | 0.70% | 99.30% |
| s8c2r3-levi | 2445.88 | 0.70% | 99.30% |
| s8c2r4-levi | 4843.25 | 0.30% | 99.70% |
| s2c2r1-sold | 652.58 | 82.03% | 17.97% |

When the control signal (group size) is set to a natural number, in a case where the control signal (group size) is set to be equal to or larger than the total number of vertices, the absolute value is large, and thus the code amount is large.

Therefore, it is also possible to make the control signal logarithmic. Specifically, with the control signal as log 2_group_size, the group size may be calculated according to the following Expression (4).

$$group size = {2}^{log 2 \_ group \_ size} \qquad Expression ( 4 )$$

Here, if there is only one group in the frame, the group is set as the last group. That is, when group size is larger than the number of vertices, all vertices are put into a group.

The range that can be set in the above-described control signal may be a clear value, or may be calculated from other control signals or data.

For example, the settable range in the control signal may be defined by Level 1.

Alternatively, the settable range in the control signal may be calculated from the number of vertices of the base mesh.

For example, the settable range in the control signal may be a minimum natural number that is a power of 2 that can cover the number of vertices of the base mesh.

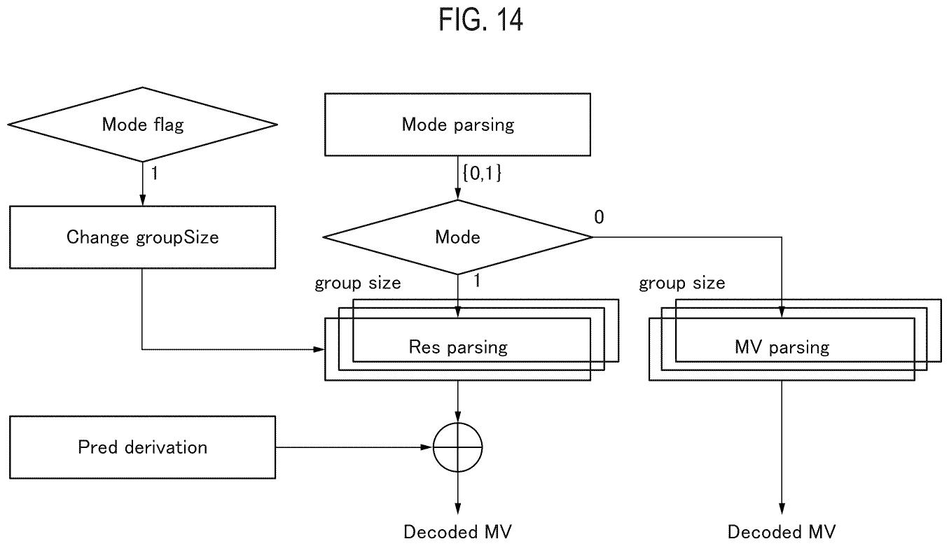

The settable range in the above-described control signal may be set to a small range, and then a predetermined flag (Mode flag) of another control signal may be introduced as illustrated in FIG. 14. In such a case, as illustrated in FIG. 14, when the predetermined flag is TRUE (Mode flag−1), the motion vector calculation unit 202E4 groups all the vertices into one (that is, the number of all vertices is set as the group size), and when the predetermined flag is FALSE, the motion vector calculation unit 202E4 keeps the group size calculated from the above-described control signal.

Note that the control signal may be set for each sequence or may be set for each frame. When the control signal is set for each sequence, the group sizes of all the frames are the same.

According to such a configuration, by determining the range in which the group size can be appropriately set, it is possible to cope with all situations, and an effect of reliably reducing the code amount of the mode and improving the encoding efficiency can be expected.

### Modification Example 1 of Base Mesh Decoding Unit 202

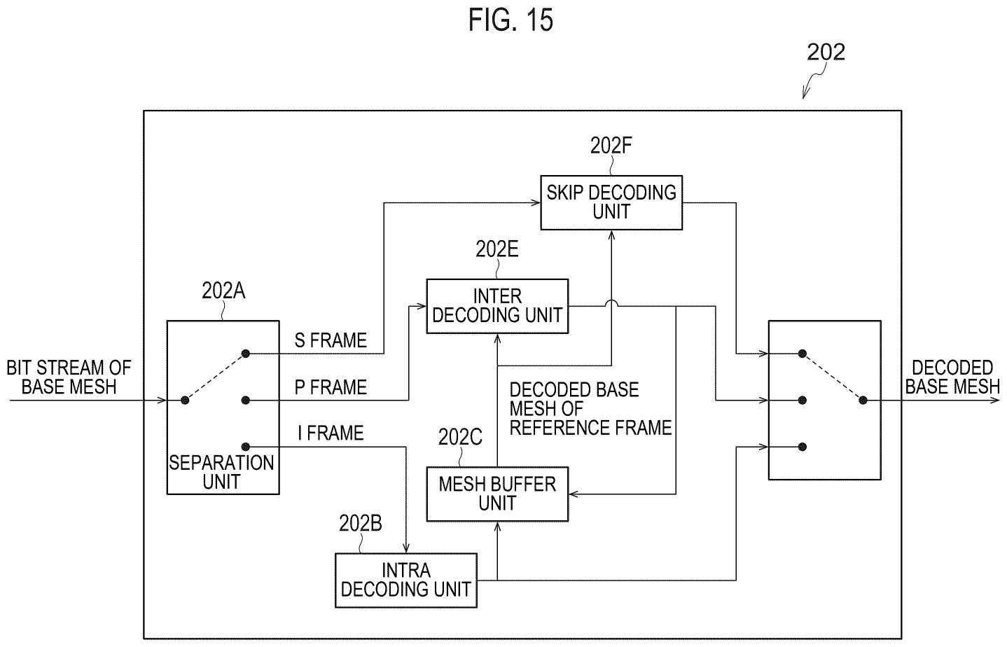

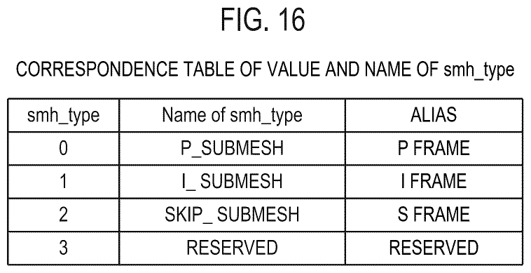

Hereinafter, Modification Example 1 of the base mesh decoding unit 202 will be described with reference to FIGS. 15 and 16.

As illustrated in FIG. 15, the base mesh decoding unit 202 according to Modification Example 1 includes a separation unit 202A, an intra decoding unit 202B, a mesh buffer unit 202C, an inter decoding unit 202E, and a skip decoding unit 202F.

The skip decoding unit 202F is configured to decode the base mesh of the frame to be decoded using the decoded base mesh of the designated reference frame as it is.

In the present embodiment, the frame may be a mesh or a submesh.

For example, as illustrated in FIG. 16, “P_SUBMESH” in smh_type may correspond to a P frame, “I_SUBMESH” in smh_type may correspond to an I frame, and “SKIP_SUBMESH” in smh_type may correspond to an S frame.

### (Skip Decoding Unit 202F)

The skip decoding unit 202F is configured to extract the decoded base mesh (reference decoded base mesh) of the reference frame designated from the mesh buffer unit 202C, and decode the coordinates of the vertex of the base mesh of the frame to be decoded and the index of the vertex using the coordinates of the vertex of the extracted reference decoded base mesh and the index of the vertex as they are.

Here, the mesh buffer unit 202C has at least one reference frame, and is configured to store at least one decoded base mesh for each reference frame.

The skip decoding unit 202F may specify a designated reference decoded base mesh using the control signal decoded from the bit stream or a predetermined rule.

For example, such a predetermined rule may be extracting the first reference frame of the reference frame list from the mesh buffer unit 202C or extracting the reference frame having the closest frame index to the frame to be decoded.

In the present embodiment, a frame for decoding the coordinates of the vertex of the base mesh using the coordinates of the vertex of the reference decoded base mesh and the index of the vertex as they are is referred to as an “S frame”.

According to such a configuration, since the motion vector can be made unnecessary in the skip decoding unit 202F, a significant reduction effect of the code amount and a significant reduction effect of the calculation amount can be expected.

### (Mesh Buffer Unit 202C)

The mesh buffer unit 202C is configured to store one or a plurality of reference decoded base meshes in a predetermined order.

Note that such a base mesh has metadata such as a frame number and a submesh number, at least coordinates of each vertex, and an index of the vertex, and is stored in the mesh buffer unit 202C in a predetermined order determined in the reference frame list.

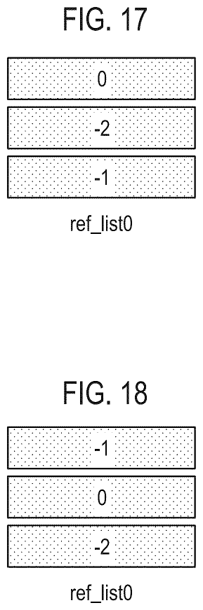

Here, as illustrated in FIG. 17, the reference frame list (ref_list0) is a list of information specifying all reference decoded base meshes stored in the mesh buffer unit 202C.

As illustrated in FIG. 17, the reference frame list may be determined by the control signal decoded from the bit stream, or may be naturally calculated from the decoding order of the frames.

Note that the control signal decoded from the bit stream may be indicated by a relative distance to the frame to be decoded or may be a frame index that is an absolute value.

Further, a short-term reference frame or a long-term reference frame may be used by the control signal.

For example, when a short-term reference frame is used, the absolute value (abs_delta_mfoc_st) of the difference between the display order (Display Order) of the frame (cur) and the reference frame (ref) and the sign (sign_flag) thereof may be decoded from the bit stream, and the display order (Display Order) of the reference frame may be designated by the following expression.

```
  If(sign_flag) {
  Display Order(ref)=Display
Order(cur)+abs_delta_mfoc_st
  }else{
  Display Order(ref)=Display Order(cur)−
abs_delta_mfoc_st
  }
```

Furthermore, in a case where the method of naturally calculating the reference frame list from the decoding order of the frames is used, for example, when there is no control signal in the reference frame list, the frames may be sequentially arranged in a certain number of frames from the previously decoded frame. That is, the reference frame list may be {0, −1, −2, . . . , −(N−1)}.

Basically, the reference frame list does not change in each frame except for special circumstances (for example, when a re-ordering instruction is received).

The mesh buffer unit 202C may be updated as follows.

When the base mesh is decoded, in the case of the I frame and the P frame, the mesh buffer unit 202C deletes one or a plurality of existing reference frames in a predetermined order determined in the reference frame list, and adjusts the order of the reference frames by adding one or a plurality of base meshes including the base mesh of the decoded frame, or by creating and adding one base mesh from the plurality of base meshes.

Such deletion work may be performed only when the mesh buffer unit 202C expires. Note that the number of base meshes that can be stored in the mesh buffer unit 202C is determined in advance. Here, in the present embodiment, it is defined that the mesh buffer unit 202C expires when such number of base meshes is reached.

In the creation work described above, the coordinates of vertices corresponding to the base mesh of the decoded frame and the existing base mesh stored in the mesh buffer unit 202C may be weighted and averaged to form one base mesh.

The weight used in such weighted-averaging may be determined in advance, may be calculated using the frame index, or may be decoded from the control signal.

However, when the frame is the S frame, the mesh buffer unit 202C may perform such update or does not have to perform such update.

When receiving a control signal indicating an instruction for re-ordering on the basis of the control signal decoded from the bit stream, the mesh buffer unit 202C updates the reference frame list as illustrated in FIG. 18, and adjusts the order of the reference frames according to the predetermined order determined in the updated reference frame list (ref_list0).

### (Inter Decoding Unit 202E)

The inter decoding unit 202E is configured to decode the coordinates of the vertex of the P frame by adding the coordinates of the vertex of the reference frame extracted from the mesh buffer unit 202C and the motion vector decoded from the bit stream of the P frame.

The inter decoding unit 202E can adjust the index of the vertex of the P frame by the pair of indices A (k) and B (k) of the vertex existing as the overlapping vertex stored in the specific buffer. All or some of the indexes are decoded from the bit stream. Such a decoding method may be arithmetic encoding. According to such a configuration, an effect that the maximum value of the index to be decoded using the arithmetic encoding is not limited can be expected. For example, the arithmetic encoding of ue(v) may be used.

### Modification Example 2 of Base Mesh Decoding Unit 202

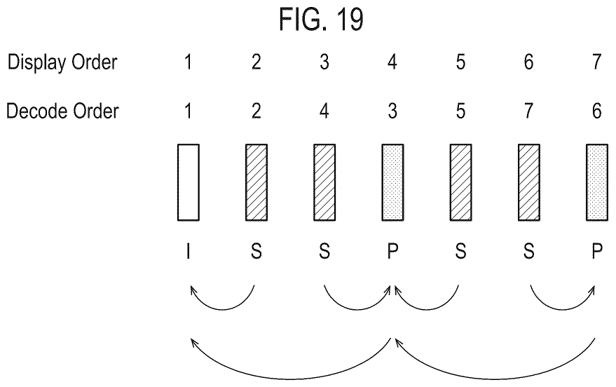

Hereinafter, Modification Example 2 of the base mesh decoding unit 202 will be described with reference to FIG. 19.

The skip decoding unit 202F will be described below, but may be applied to the inter decoding unit 202E.

As illustrated in FIG. 19, in the skip decoding unit 202F, the decoding order (Decode Order) and the display order (Display Order) are different in order to enable reference to the subsequent frame.

Here, the display order is the same as the order of input at the time of encoding, and is the same as the order of output at the time of decoding.

On the other hand, the decoding order is the same as the order of output at the time of encoding, and is the same as the order of input at the time of decoding.

Note that such a reference frame may be calculated by weighting and averaging the subsequent frame and one or a plurality of other frames.

However, in the case of referring to a plurality of frames including the subsequent frame, MR SUBMESH (MR frame or B frame) is defined as the new frame type (smh_type) in FIG. 14, and MR SUBMESH is decoded from the bit stream.

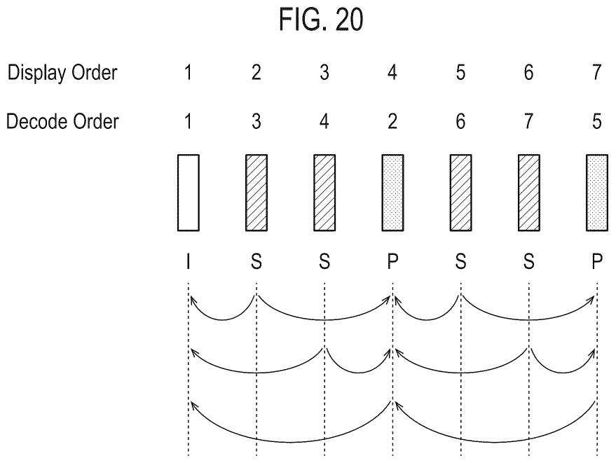

Furthermore, as illustrated in FIG. 20, such another frame may be a decoded frame immediately before the target frame.

Such a weight may be calculated using a frame interval between the target frame and the subsequent frame and a frame interval between the target frame and another frame, or may be determined in advance.

The base mesh decoding unit 202 decodes the control signal (smh_mesh_frm_order_cnt_lsb) from the bit stream, and decodes the output order.

Note that, when there are the submeshes defined in Non Patent Literature 4 (“WD 3.0 of V-DMC,” April 2023, ISO/IEC JTC 1/SC 29/WG 7 N00611) described above, all the submeshes are set to the same control signal (smh_mesh_frm_order_cnt_lsb), or the control signal (smh_mesh_frm_order_cnt_lsb) is applied to all the submeshes.

The value indicated by the control signal (smh_mesh_frm_order_cnt_lsb) may be a difference from the display order of the frame to be decoded, or may be an order in a frame group MaxMeshFrmOrderCntLsb determined in advance.

When the decoding order (Decode Order) and the display order (Display Order) are different and the decoded base meshes are arranged in the decoding order (Decode Order), the base mesh decoding unit 202 may rearrange the decoded base meshes in the display order (Display Order).

Note that, in the S frame in which the subsequent frame can be referred to, two mesh buffer units 202C may be provided, or when only one mesh buffer unit 202 is provided, at least one reference frame including a reference frame of which the display order is later than the frame to be decoded exists.

The skip decoding unit 202F designates the reference frame according to the control signal decoded from the bit stream or a predetermined rule, or by receiving re-ordering instruction.

Specifically, the skip decoding unit 202F designates a reference frame in the reference frame list according to such control signal.

Alternatively, the skip decoding unit 202F designates the first reference frame in the reference frame list.

Alternatively, the skip decoding unit 202F updates the reference frame list and the reference frame order of the mesh buffer unit 202C in response to the re-ordering instruction, and designates the first reference frame in such a reference frame list.

Note that, in the present embodiment, decoding of other frames is not affected even if the S frame is not decoded. Therefore, in a case where the S frame is not partially or entirely decoded, temporal scalability can be realized.

The base mesh decoding unit 202 may decode the base mesh of the S frame by integrating a plurality of reference frames according to the control signal.

For example, the base mesh decoding unit 202 may be configured to average the coordinates of the corresponding vertices in the base meshes of the two preceding and following reference frames, and decode the coordinates of the vertex of the base mesh of the frame to be decoded and the index of the vertex using the average coordinates and the index of the vertex as they are.

According to such a configuration, it is possible to obtain a high-quality base mesh while eliminating the need for motion vectors in the skip decoding unit 202F or the inter decoding unit 202E, so that an effect of improving the quality of the decoded mesh can be expected. Furthermore, an effect of realizing temporal scalability can be expected.

However, in order to realize temporal scalability, control signals Temporal_ID respectively indicating whether to decode the base mesh, the DISPLACEMENT, and the texture in each frame are defined, and decoded from the bit stream.

In the case of the same frame, the control signals Tempora_ID for the base mesh, the DISPLACEMENT, and the texture are caused to match each other. If the control signals Tempora_ID for the base mesh to be decoded, the DISPLACEMENT, and the texture match, an effect of avoiding a frame that cannot be decoded and avoiding unnecessary data can be avoided can be expected.

It is desirable that an interval between adjacent frames having the same Tempora_ID be constant.

Adjacent frames having the same Tempora_ID are closest in POC.

By making the interval between the frames constant as described above, an effect of maintaining a constant frame rate when displaying the decoded frame can be expected.

Further, the decoding orders of the base mesh, the DISPLACEMENT, and the texture having the same display order are caused to match.

As described above, when the decoding orders are caused to match, an effect that the mesh can be reproduced without waiting for mutual decoding when the base mesh, the DISPLACEMENT, and the texture are decoded can be expected.

If the decoding orders of the base mesh, the DISPLACEMENT, and the texture are different, it is necessary to wait for the slowest decoded component, and thus there is a problem that the buffer usage increases and a decoding delay occurs.

Further, a frame having Temporal_ID higher than the control signal Temporal_ID of the frame to be decoded is not used as such a reference frame of the frame to be decoded.

As a result, it is possible to expect an effect that there is no possibility that the reference frame is discarded.

Hereinafter, an example of realizing the temporal scalability using the above-described temporal_ID will be described.

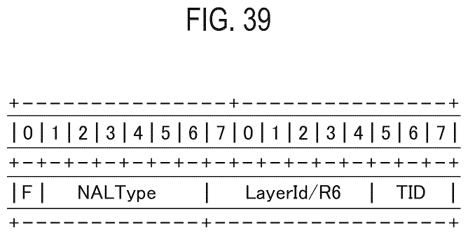

The bit streams of the base mesh, the DISPLACEMENT, and the texture are encapsulated by a network abstraction layer (NAL) unit. The NAL unit may have a NAL header as illustrated in FIG. 39.

The TID defined as the last 3 bits in the NAL header is Temporal_ID plus 1. The range of the TID is from 1 to 7, and zero is prohibited.

Note that when there are submeshes defined in Non Patent Literature 4, all the submeshes are set to the same TID, or the TID is applied to all the submeshes. Since HEVC or VVC of a video coding system is used for the DISPLACEMENT and the texture, only the base mesh will be described below.

In a case where NALType is in a range from NAL_BLA_W_LP defined in Non Patent Literature 4 to NAL_RSV_BMCL_29, that is, NALType belongs to an IRAP coded base mesh frame, Temporal_ID must be 0.

If NALType is equal to NAL TSA R or NAL TSA N, Temporal_ID should not be equal to 0.

When NALType is equal to 0 and NALType is equal to NAL_STSA_R or NAL_STSA_N, Temporal_ID should not be equal to 0.

The value of Temporal_ID should be the same for all BMCL NAL units in the access unit.

The value of Temporal_ID of the coded base mesh frame or the access unit is a value of Temporal_ID of the BMCL NAL unit of the coded base mesh frame or the access unit.

The value of Temporal_ID in the sublayer representation is the maximum value of Temporal_IDs of all BMCL NAL units in the sublayer representation.

A value of Temporal_ID of the non-BMCL NAL unit is limited as follows:
If NALType is equal to NAL_BMSPS, Temporal_ID should be 0, and Temporal_ID of the access unit including the NAL unit must be 0.
Otherwise, if NALType is equal to NAL_EOS or NAL_EOB, Temporal_ID must be 0.
Otherwise, if NALType is equal to NAL AUD or NALLFDD, Temporal_ID must be equal to Temporal_ID of the access unit including the NALL unit.
Otherwise, Temporal_ID must be greater than or equal to Temporal_ID of the access unit including the NAL unit.

If the NAL unit is not the BMCL, the value of Temporal_ID is equal to the minimum value of Temporal_ID values of all the access units to which the non-BMCL NAL unit is applied.

If NALType is equal to NAL_BMFPS, Temporal_ID may be equal to or greater than Temporal_ID of the included access unit since all base mesh frame parameter sets (BMFPS) are included at the beginning of the bit stream of which Temporal_ID is 0 for the first encoded base mesh frame.

### <Subdivision Unit 203>

A subdivision unit 203 is configured to generate and output the added SUBDIVIDED VERtices and their connectivity information from the base mesh decoded by the base mesh decoding unit 202 by a subdivision method indicated by the control information.

Here, the base mesh, the added SUBDIVIDED VERtex, and the connectivity information thereof are collectively referred to as a “subdivided mesh”.

The subdivision unit 202 is configured to identify the type of the subdivision method from subdivision method id which is control information generated by decoding the base mesh bit stream.

Hereinafter, the subdivision unit 202 will be described with reference to FIGS. 3A and 3B.

FIGS. 3A and 3B are diagrams for describing an example of an operation of generating a SUBDIVIDED VERtex from a base mesh.

FIG. 3A is a diagram illustrating an example of a base mesh including five vertices.

Here, for the subdivision, for example, a mid-edge division method of connecting midpoints of sides in each base face may be used. As a result, a certain base face is divided into four faces.

FIG. 3B illustrates an example of a subdivided mesh obtained by dividing a base mesh including five vertices. In the subdivided mesh illustrated in FIG. 3B, eight SUBDIVIDED VERtices (white circles) are generated in addition to the original five vertices (black circles).

By decoding the DISPLACEMENT by the displacement decoding unit 206 for each SUBDIVIDED VERtex generated in this manner, improvement in encoding performance can be expected.

In addition, a different subdivision method may be applied to each patch. Therefore, the DISPLACEMENT decoded by the displacement decoding unit 206 is adaptively changed in each patch, and the improvement of the encoding performance can be expected. Information regarding the divided patch is received as patch_id that is control information.

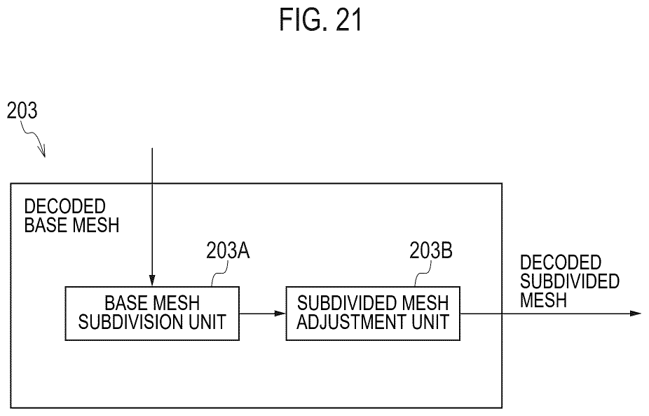

Hereinafter, the subdivision unit 203 will be described with reference to FIG. 21. FIG. 21 is a diagram illustrating an example of functional blocks of the subdivision unit 203.

As illustrated in FIG. 21, the subdivision unit 203 includes a base mesh subdivision unit 203A and a subdivided mesh adjustment unit 203B.

### (Base Mesh Subdivision Unit 203A)

The base mesh subdivision unit 203A is configured to calculate the number of divisions (the number of subdivisions) for each of the base face and the base patch based on the input base mesh and the division information of the base mesh, subdivide the base mesh based on the number of divisions, and output the subdivided face.

That is, the base mesh subdivision unit 203A may be configured such that the above-described number of divisions can be changed in units of base faces and base patches.

Here, the base face is a face included in the base mesh, and the base patch is a set of several base faces.

The base mesh subdivision unit 203A may be configured to predict the number of subdivisions of the base face, and calculate the number of subdivisions of the base face by adding a predicted division number residual to the predicted number of subdivisions of the base face.

The base mesh subdivision unit 203A may be configured to calculate the number of subdivisions of the base face based on the number of subdivisions of an adjacent base face of the base face.

The base mesh subdivision unit 203A may be configured to calculate the number of subdivisions of the base face based on the number of subdivisions of the base face accumulated immediately before.

The base mesh subdivision unit 203A may be configured to generate vertices that divide three sides forming the base face, and subdivide the base face by connecting the generated vertices.

As illustrated in FIG. 21, 203B including the subdivided mesh adjustment unit that will be described later is included at a subsequent stage of the base mesh subdivision unit 203A.

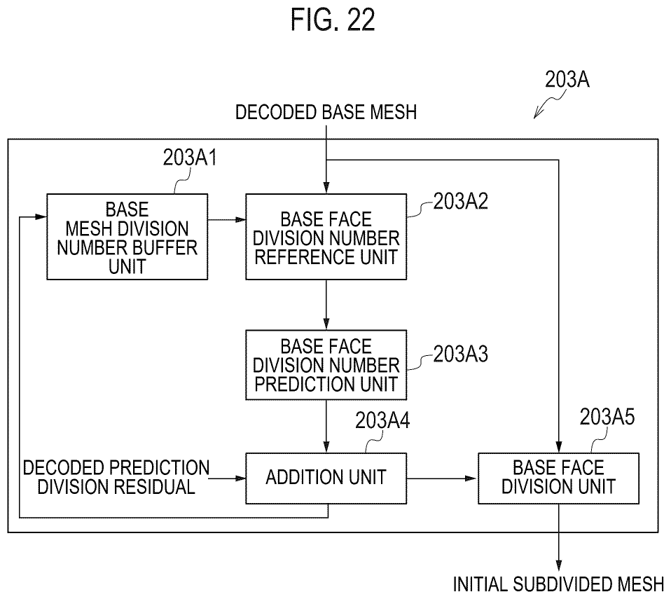

Hereinafter, an example of processing in the base mesh subdivision unit 203A will be described with reference to FIGS. 22 to 24.

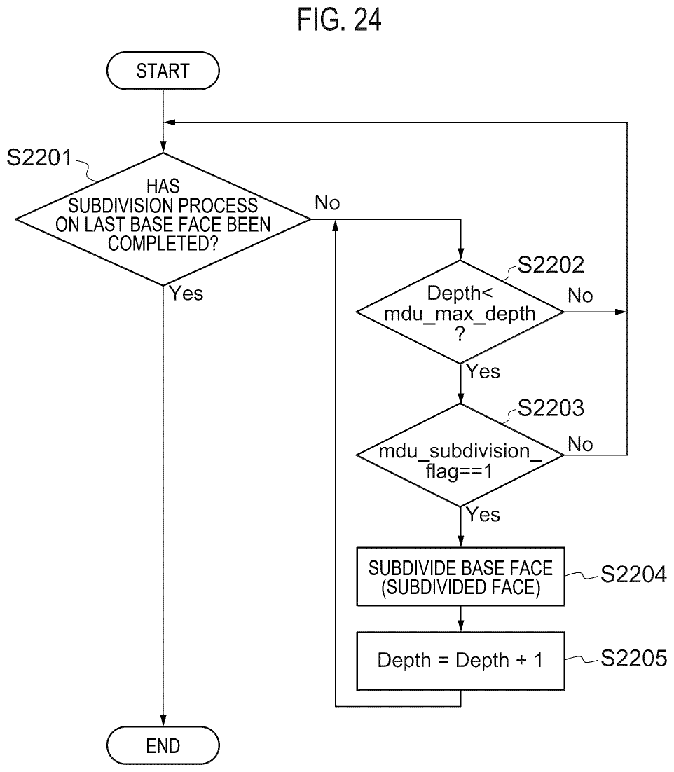

FIG. 22 is a diagram illustrating an example of functional blocks of the base mesh subdivision unit 203A, and FIG. 24 is a flowchart illustrating an example of an operation of the base mesh subdivision unit 203A.

As illustrated in FIG. 22, the base mesh subdivision unit 203A includes a base face division number buffer unit 203A1, a base face division number reference unit 203A2, a base face division number prediction unit 203A3, an addition unit 203A4, and a base face division unit 203A5.

The base face division number buffer unit 203A1 stores division information of the base face including the number of divisions of the base face, and is configured to output the division information of the base face to the base face division number reference unit 203A2.

Here, the size of the base face division number buffer unit 203A1 may be set to 1, and the number of divisions of the base face accumulated immediately before may be output to the base face division number reference unit 203A2.

That is, by setting the size of the base face division number buffer unit 203A1 to 1, only the number of subdivisions last decoded (the number of subdivisions decoded immediately before) may be referred to.

In a case where the base face adjacent to the base face to be decoded does not exist, or in a case where the base face adjacent to the base face to be decoded exists but the number of divisions is not fixed, the base face division number reference unit 203A2 is configured to output “reference impossible” to the base face division number prediction unit 203A3.

On the other hand, the base face division number reference unit 203A2 is configured to output the number of divisions to the base face division number prediction unit 203A3 in a case where the base face adjacent to the base face to be decoded exists and the number of divisions is determined.

The base face division number prediction unit 203A3 is configured to predict the number of divisions (the number of subdivisions) of the base face based on the one or more input numbers of divisions, and output the predicted number of divisions (prediction division number) to the addition unit 203A4.

Here, the base face division number prediction unit 203A3 is configured to output 0 to the addition unit 203A4 in a case where only “reference impossible” is input from the base face division number reference unit 203A2.

Note that the base face division number prediction unit 203A3 may be configured to generate, in a case where one or more numbers of divisions are input, the prediction division number by using any one of statistical values such as an average value, a maximum value, a minimum value, and a mode value of the input number of divisions.

Note that the base face division number prediction unit 203A3 may be configured to generate the number of divisions of the most adjacent face as the prediction division number when one or more numbers of divisions are input.

The addition unit 203A4 is configured to output, to the base face division unit 203A5, the number of divisions obtained by adding the prediction division number residual decoded from a prediction residual bit stream and the prediction division number acquired from the base face division number prediction unit 203A3.

The base face division unit 203A5 is configured to subdivide the base face based on the input number of divisions from the addition unit 203A4.

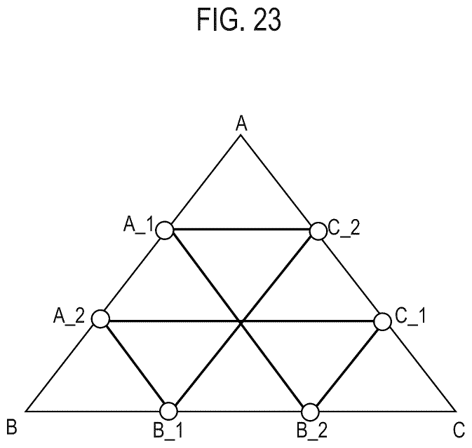

FIG. 23 illustrates an example of a case where the base face is divided into nine. A method of dividing the base face by the base face division unit 203A5 will be described with reference to FIG. 23.

The base face division unit 203A5 generates points A_1, . . . , A_(N−1) equally dividing the edge AB constituting the base face into N (N=3).

Similarly, the base face division unit 203A5 equally divides the edge BC and the edge CA into N to generate points B_1, . . . , B_(N−1), C_1, . . . , C_(N−1), respectively.

Hereinafter, points on the edge AB, the edge BC, and the edge CA are referred to as “edge division points”.

The base face division unit 203A5 generates edges A_i B_(N-i), B_i C_(N-i), and C_i A (N-i) for all i (i=1, 2, . . . , and N−1), and generates N2 subdivided faces.

Next, a processing procedure of the base mesh subdivision unit 203A will be described with reference to FIG. 24.

In step S2201, the base mesh subdivision unit 203A determines whether the subdivision process on the last base face has been completed. In a case where the processing has been completed, the processing procedure ends, and if the processing has not been completed, the processing procedure proceeds to step S2202.

In step S2202, the base mesh subdivision unit 203A determines Depth<mdu_max_depth.

Here, Depth is a variable representing the current depth, the initial value is 0, and mdu_max_depth represents the maximum depth determined for each base face.

In a case where the condition in step S2202 is satisfied, the processing procedure proceeds to step S2203, and in a case where such a condition is not satisfied, the processing procedure returns the process to step S2201.

In step S2203, the base mesh subdivision unit 203A determines whether or not mdu_subdivision_flag at the current depth is 1.

In the case of Yes, the processing procedure returns to step S2201, and in the case of No, the processing procedure proceeds to step S2204.

In step S2204, the base mesh subdivision unit 203A further subdivides all the subdivided faces in the base face.

Here, the base mesh subdivision unit 203A subdivides the base face in a case where subdivision processing has never been performed on the base face.

Note that the subdivision method is similar to the method described in step S2204.

Specifically, in a case where the base face has never been subdivided, the base face is subdivided as illustrated in FIG. 23. In a case where the base face has been subdivided at least once, the subdivided face is subdivided into N2. In the example of FIG. 23, the face including the vertex A_2, the vertex B, and the vertex B_1 is further divided by a same method as in the division of the base face to generate N² faces. When the subdivision processing ends, the processing procedure proceeds to step S2205.

In step S2205, the base mesh subdivision unit 203A adds 1 to Depth, and the processing procedure returns to step S2202.

### (Subdivided Mesh Adjustment Unit 203B)

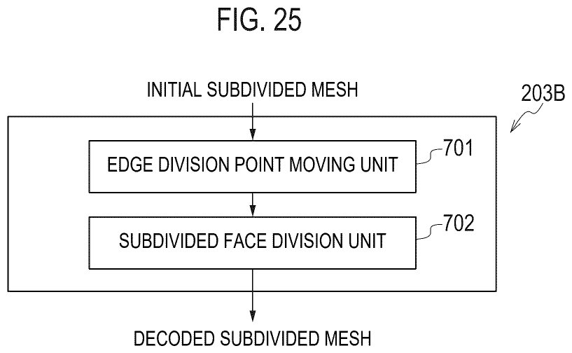

Next, a specific example of processing performed by the subdivided mesh adjustment unit 203B will be described. Hereinafter, an example of processing performed by the subdivided mesh adjustment unit 203B will be described with reference to FIGS. 25 to 28.

FIG. 25 is a diagram illustrating an example of functional blocks of the subdivided mesh adjustment unit 203B.

As illustrated in FIG. 25, the subdivided mesh adjustment unit 203B includes an edge division point moving unit 701 and a subdivided face division unit 702.

### (Edge Division Point Moving Unit 701)

The edge division point moving unit 701 is configured to move the edge division point of the base face to any of the edge division points of the adjacent base faces with respect to the input initial subdivided face, and output the subdivided face.

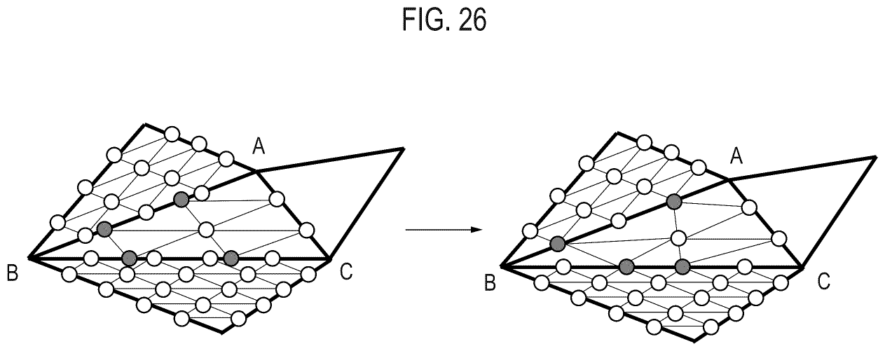

FIG. 26 illustrates an example in which an edge division point on a base face ABC is moved. For example, as illustrated in FIG. 26, the edge division point moving unit 701 may be configured to move the edge division point of the base face ABC to the edge division point of the closest adjacent base face.

### (Subdivided Face Division Unit 702)

The subdivided face division unit 702 is configured to subdivide the input subdivided face again and output a decoding subdivided face.

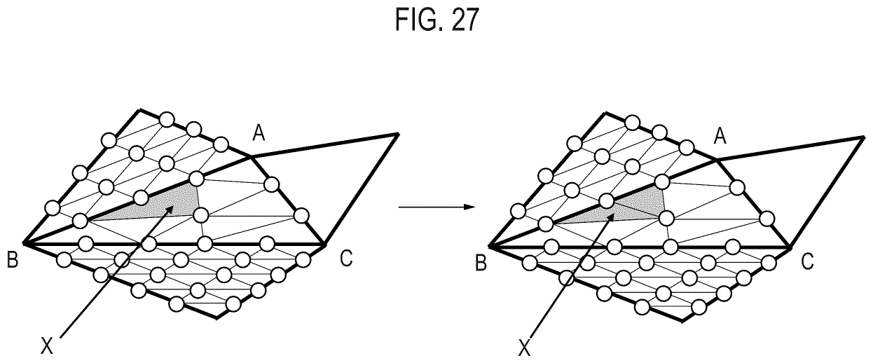

FIG. 27 is a diagram illustrating an example of a case where a subdivided face X in the base face is subdivided again.

As illustrated in FIG. 27, the subdivided face division unit 702 may be configured to generate a new subdivided face in the base face by connecting a vertex forming the subdivided face and an edge division point of an adjacent base face.

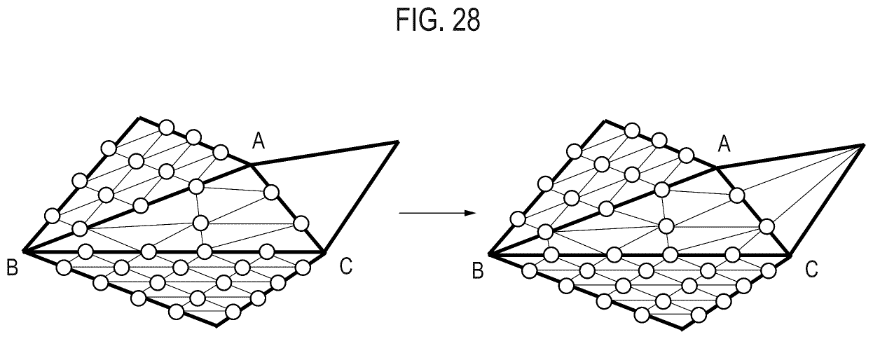

FIG. 28 is a diagram illustrating an example of a case where the above-described subdivision processing is performed on all the subdivided faces.

The mesh decoding unit 204 is configured to generate and output a decoded mesh using the subdivided mesh generated by the subdivision unit 203 and the DISPLACEMENT decoded by the displacement decoding unit 206.

Specifically, the mesh decoding unit 204 is configured to generate a decoded mesh by adding a corresponding DISPLACEMENT to each SUBDIVIDED VERtex. Here, information to which SUBDIVIDED VERtex each DISPLACEMENT corresponds is indicated by the control information.

The patch integration unit 205 is configured to integrate and output a plurality of patches of the decoded mesh generated by the mesh decoding unit 206.

Here, a patch division method is defined by the mesh encoding device 100. For example, the patch division method may be configured such that a normal vector is calculated for each base face, a base face having the most similar normal vector among adjacent base faces is selected, both base faces are grouped as the same patch, and such a procedure is sequentially repeated for the next base face.

The video decoding unit 207 is configured to decode and output texture by video coding. For example, the video decoding unit 207 may use HEVC.

### <Displacement Decoding Unit 206>

The displacement decoding unit 206 is configured to decode a displacement bit stream to generate and output a DISPLACEMENT.

FIG. 3B is a diagram illustrating an example of a DISPLACEMENT with respect to a certain SUBDIVIDED VERtex. In the example of FIG. 3B, since there are eight SUBDIVIDED VERtices, the displacement decoding unit 206 is configured to define eight DISPLACEMENTs expressed by scalars or vectors for each SUBDIVIDED VERtex.

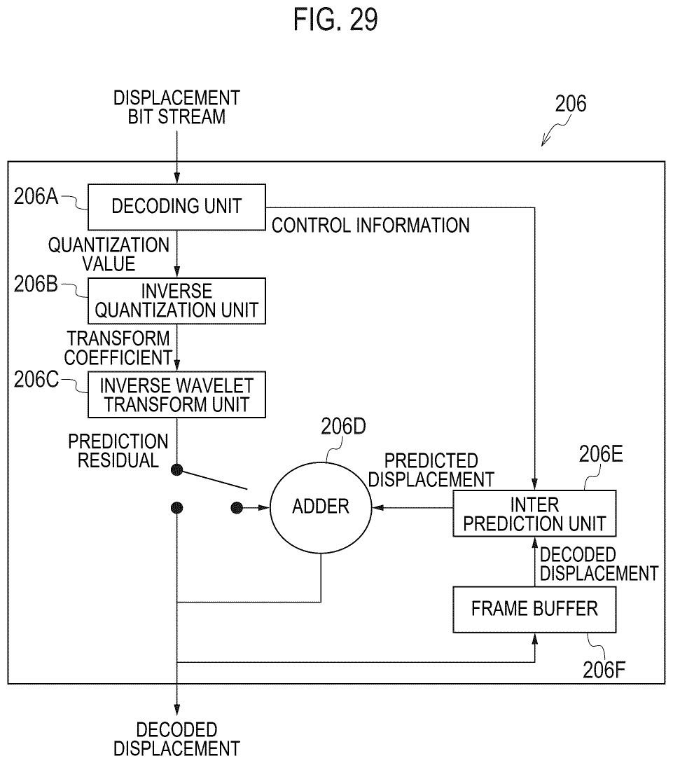

The displacement decoding unit 206 will be described below with reference to FIG. 29. FIG. 29 is a diagram illustrating an example of functional blocks of the displacement decoding unit 206.

As illustrated in FIG. 29, the displacement decoding unit 206 includes a decoding unit 206A, an inverse quantization unit 206B, an inverse wavelet transform unit 206C, an adder 206D, an inter prediction unit 206E, and a frame buffer 206F.

The decoding unit 206A is configured to decode and output the level value and the control information by performing variable-length decoding on the received displacement bit stream. Here, the level value obtained by the variable-length decoding is output to the inverse quantization unit 206B, and the control information is output to the inter prediction unit 206E.

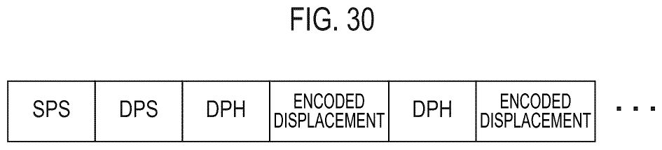

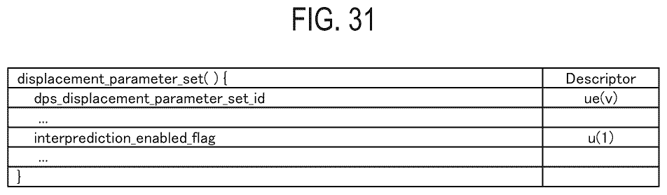

Hereinafter, an example of a configuration of the displacement bit stream will be described with reference to FIG. 30. FIG. 30 is a diagram illustrating an example of the configuration of the displacement bit stream.

As illustrated in FIG. 30, first, the displacement bit stream may include a displacement parameter set (DPS) that is a set of control information related to decoding of the DISPLACEMENT.

Second, the displacement bit stream may include a displacement patch header (DPH) that is a set of control information corresponding to the patch.

Third, the displacement bit stream may contain the encoded DISPLACEMENT which, next to the DPH, constitutes a patch.

As described above, the displacement bit stream has a configuration in which one DPH and one DPS correspond to each encoded DISPLACEMENT.

Note that the configuration in FIG. 30 is merely an example. When the DPH and the DPS are configured to correspond to each encoded DISPLACEMENT, elements other than the above may be added as constituent elements of the displacement bit stream.

For example, as illustrated in FIG. 30, the displacement bit stream may include a sequence parameter set (SPS).

FIG. 31 is a diagram illustrating an example of a syntax configuration of the DPS.

A Descriptor column in FIG. 31 indicates how each syntax is encoded.

Further, in FIG. 31, ue(v) means an unsigned 0-order exponential-Golomb code, and u (n) means an n-bit flag.

In a case where there are a plurality of DPSs, the DPS includes at least DPS id information (dps_displacement_parameter_set_id) for identifying each DPS.

Further, the DPS may include a flag (interprediction_enabled_flag) that controls whether or not to perform inter-prediction.

For example, when interprediction_enabled_flag is 0, it may be defined that inter-prediction is not performed, and when interprediction_enabled_flag is 1, it may be defined that inter-prediction is performed. When interprediction_enabled_flag is not included, it may be defined that inter-prediction is not performed.

The DPS may include a flag (dct_enabled_flag) that controls whether or not to perform inverse DCT.

For example, when dct_enabled_flag is 0, it may be defined that the inverse DCT is not performed, and when dct_enabled_flag is 1, it may be defined that the inverse DCT is performed. When dct_enabled_flag is not included, it may be defined that the inverse DCT is not performed.

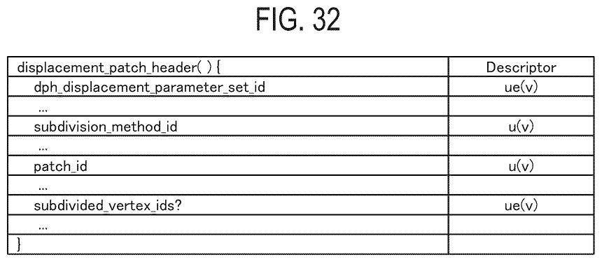

FIG. 32 is a diagram illustrating an example of a syntax configuration of the DPH.

As illustrated in FIG. 32, the DPH includes at least DPS id information for designating a DPS corresponding to each DPH.

The inverse quantization unit 206B is configured to generate and output a transform coefficient by inversely quantizing the level value decoded by the decoding unit 206A.

The inverse wavelet transform unit 206C is configured to generate and output a prediction residual by applying an inverse wavelet transform to the transform coefficient generated by the inverse quantization unit 206B.

### (Inter Prediction Unit 206E)

The inter prediction unit 206E is configured to generate and output a predicted DISPLACEMENT by performing inter-prediction using the decoded DISPLACEMENT of the reference frame read from the frame buffer 206F.

The inter prediction unit 206E is configured to perform such inter-prediction only in a case where interprediction_enabled_flag is 1.

The inter prediction unit 206E may perform inter-prediction in the spatial domain or may perform inter-prediction in the frequency domain. In the inter-prediction, bidirectional prediction may be performed using a past reference frame and a future reference frame in terms of time.

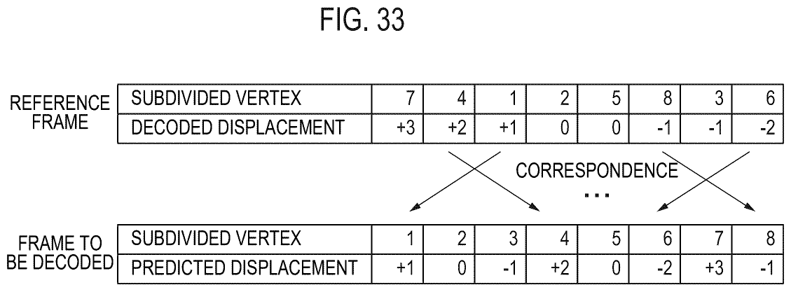

FIG. 33 is a diagram for describing an example of a correspondence of SUBDIVIDED VERtices between a reference frame and a frame to be decoded in a case where inter-prediction is performed in a spatial domain.

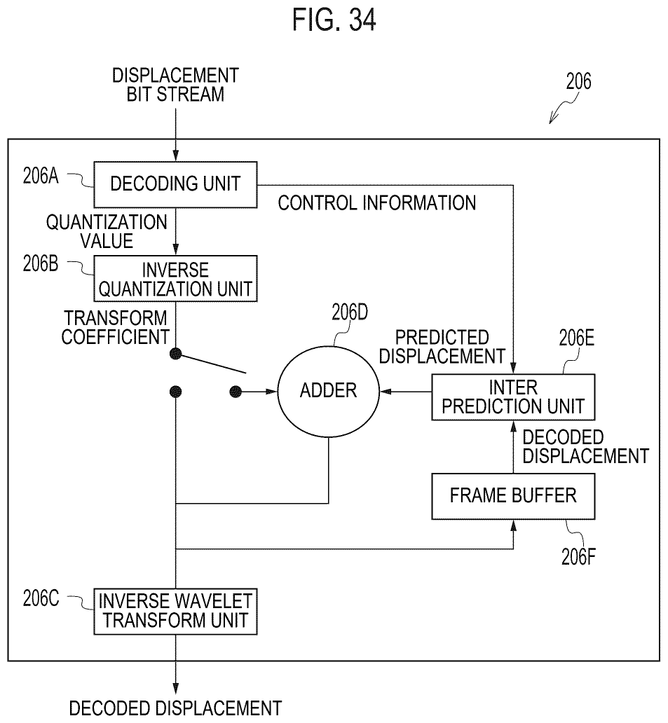

FIG. 34 is an example of functional blocks of the inter prediction unit 206E in a case where inter-prediction is performed in the frequency domain.

In a case where inter-prediction is performed in the frequency domain, the inter prediction unit 206E may determine the predicted wavelet transform coefficient of the frequency in the frame to be decoded with reference to the decoded wavelet transform coefficient of the corresponding frequency in the reference frame as it is.

The inter prediction unit 206E may probabilistically perform inter-prediction according to a normal distribution in which the average and the variance are estimated using the decoded DISPLACEMENTS of the SUBDIVIDED VERtices or decoded wavelet transform coefficients in the plurality of reference frames.

The inter prediction unit 206E may perform inter-prediction based on a regression curve in which time is estimated as an explanatory variable and a DISPLACEMENT is estimated as an objective variable, using a decoded DISPLACEMENT or a decoded wavelet transform coefficient of the SUBDIVIDED VERtices in a plurality of reference frames.

The inter prediction unit 206E may be configured to bidirectionally perform inter-prediction using a past reference frame and a future reference frame in terms of time.

In the mesh encoding device 100, the order of the decoding wavelet transform coefficients may be rearranged for each frame in order to improve the encoding efficiency.

A correspondence of frequencies between the reference frame and the frame to be decoded is indicated by the control information.

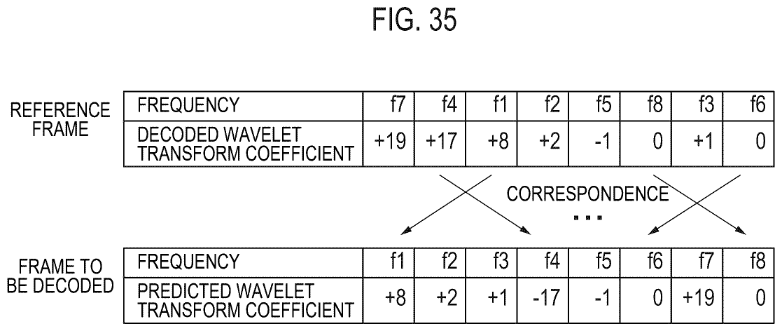

FIG. 35 is a diagram for describing an example of a correspondence of frequencies between a reference frame and a frame to be decoded in a case where inter-prediction is performed in a frequency domain.

In a case where the subdivision unit 203 divides the base mesh into a plurality of patches, the inter prediction unit 206E is also configured to perform inter-prediction for each divided patch. As a result, the time correlation between frames is increased, and improvement in encoding performance can be expected.

The adder 206D receives the prediction residual from the inverse wavelet transform unit 206C, and receives the predicted DISPLACEMENT from the inter prediction unit 206E.

The adder 206D is configured to calculate to output the decoded DISPLACEMENT by adding the prediction residual and the predicted DISPLACEMENT.

The decoded DISPLACEMENT calculated by the adder 206D is also output to the frame buffer 206F.

The frame buffer 206F is configured to acquire and accumulate the decoded DISPLACEMENT from the adder 206D.

Here, the frame buffer 206F outputs the decoded DISPLACEMENT at the corresponding vertex in the reference frame according to control information (not illustrated).

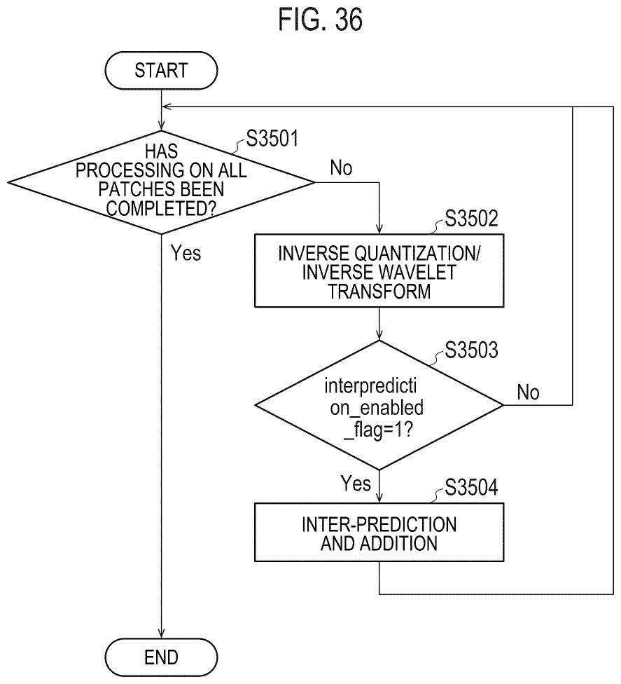

FIG. 36 is a flowchart illustrating an example of an operation of the displacement decoding unit 206.

As illustrated in FIG. 36, in step S3501, the displacement decoding unit 206 determines whether the present processing is completed for all the patches.

In the case of Yes, the present operation ends, and in the case of No, the present operation proceeds to step S3502.

In step S3502, the displacement decoding unit 206 performs inverse DCT and then performs inverse quantization and inverse wavelet transform on the patch to be decoded.

In step S3503, the displacement decoding unit 206 determines whether interprediction_enabled_flag is 1.

In the case of Yes, the present operation proceeds to step S3504, and in the case of No, the present operation proceeds to step S3501.

In step S3504, the displacement decoding unit 206 performs the above inter-prediction and addition.

### Modification Example 1

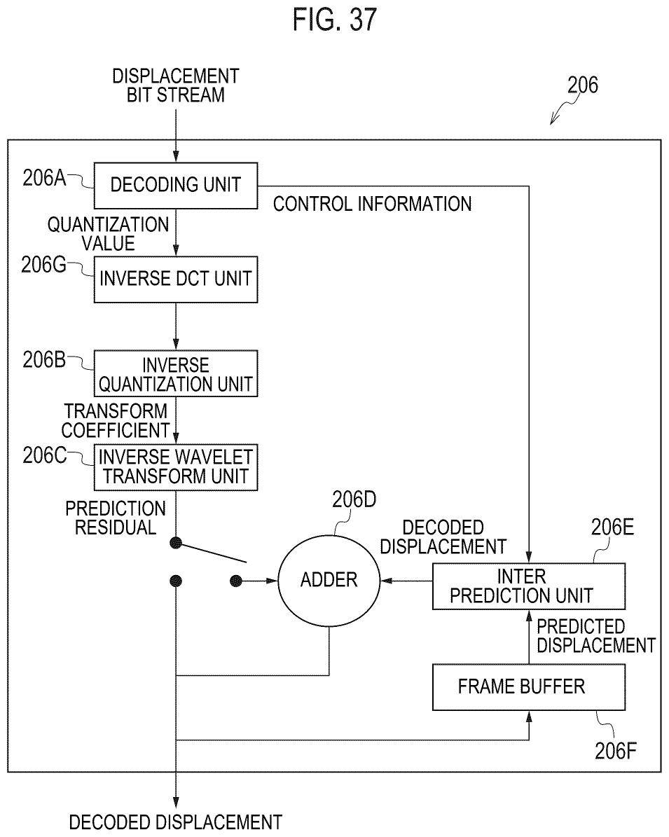

Hereinafter, with reference to FIG. 37, Modification Example 1 of the above-described first embodiment will be described focusing on differences from the first embodiment described above.

FIG. 37 is a diagram illustrating an example of functional blocks of the displacement decoding unit 206 according to Modification Example 1.

As illustrated in FIG. 37, the displacement decoding unit 206 according to Modification Example 1 includes an inverse DCT unit 206G at a subsequent stage of the decoding unit 206A, that is, between the decoding unit 206A and the inverse quantization unit 206B.

That is, in Modification Example 1, the inverse quantization unit 206B is configured to generate the prediction residual by applying the inverse wavelet transform to the level value output from the inverse DCT unit 202G.

### Modification Example 2

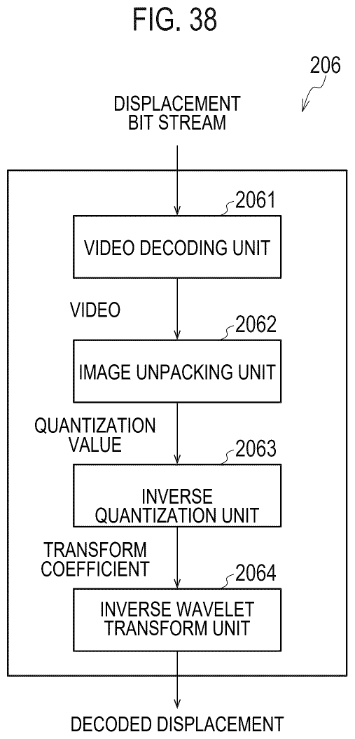

Hereinafter, with reference to FIG. 38, Modification Example 2 of the above-described first embodiment will be described focusing on differences from the first embodiment described above.

As illustrated in FIG. 38, the displacement decoding unit 206 according to Modification Example 2 includes a video decoding unit 2061, an image unpacking unit 2062, an inverse quantization unit 2063, and an inverse wavelet transform unit 2064.

The video decoding unit 2061 is configured to output a video by decoding the received displacement bit stream through video coding.

For example, the video decoding unit 2061 may use HEVC described in Non Patent Literature 1.

Further, the video decoding unit 2061 may use a video coding scheme in which the motion vector is constantly 0. For example, the video decoding unit 2061 may set the motion vector of HEVC to 0 at all times, and may constantly use inter-prediction at the same position.

Further, the video decoding unit 2061 may use a video coding scheme in which conversion is always skipped. For example, the video decoding unit 2061 may constantly set the conversion of HEVC to the conversion skip mode, and may use the video coding scheme without performing the conversion.

The image unpacking unit 2062 is configured to develop and output the video decoded by the video decoding unit 2061 as a level value for each image (frame).

In such a developing method, the image unpacking unit 2062 can identify the level value by reverse calculation from the arrangement of the level values in the image indicated by the control information.

For example, the image unpacking unit 2062 may arrange the level values from the high frequency component to the low frequency component in the order of raster operation in the image as the arrangement of the level values.

The inverse quantization unit 2063 is configured to generate and output a transform coefficient by inversely quantizing the level value generated by the image unpacking unit 2062.

The inverse wavelet transform unit 2064 is configured to generate and output a decoded DISPLACEMENT by applying an inverse wavelet transform to the transform coefficient generated by the inverse quantization unit 2063.

The mesh encoding device 100 and the mesh decoding device 200 described above may be implemented as programs that cause a computer to execute each function (each step).

According to the present embodiment, for example, comprehensive improvement in service quality can be realized in moving image communication, and thus, it is possible to contribute to the goal 9 “Build resilient infrastructure, promote inclusive and sustainable industrialization and foster innovation” of the sustainable development goal (SDGs) established by the United Nations.

What is claimed is:

1. A mesh decoding device comprising:
a motion vector residual decoding unit that generates a motion vector residual from a bit stream of an inter frame;
a motion vector prediction unit that acquires decoded motion vectors from a vertex to be decoded and surrounding vertices connected to the vertex to be decoded, and outputs a motion vector predicted value of the vertex to be decoded using all or some of the decoded motion vectors; and
a motion vector calculation unit that outputs a motion vector of the vertex to be decoded, wherein
in a mode 1, the motion vector calculation unit outputs the motion vector of the vertex to be decoded by adding the motion vector residual and the motion vector predicted value,
in a mode 0, the motion vector calculation unit outputs the motion vector residual as the motion vector of the vertex to be decoded,
the motion vector calculation unit sets the same mode for motion vectors of N (N≥1) consecutive vertices in a decoding order,
the N vertices are included in one group, and
the motion vector calculation unit decodes, from a bit stream, a control signal for calculating a group size indicating a size of the group.

2. The mesh decoding device according to claim 1, wherein
the motion vector calculation unit enables a range settable as the group size to cover 1 to a predetermined maximum value.

3. The mesh decoding device according to claim 2, wherein
the maximum value is equal to or greater than the number of all vertices of a base mesh.

4. The mesh decoding device according to claim 1, wherein
the motion vector calculation unit groups all vertices in the group into one group in a case where the group size is larger than the number of vertices in the group.

5. The mesh decoding device according to claim 1, wherein
the control signal is a natural number or a logarithm.

6. The mesh decoding device according to claim 1,
when the control signal means log 2_group_size, the group size is calculated according to the following Expression (4).
$$group size = {2}^{log 2 \_ group \_ size} . \qquad Expression ( 4 )$$

7. The mesh decoding device according to claim 4, wherein
the motion vector calculation unit calculates the group size using an exponential function in a case where the control signal is a logarithm.

8. The mesh decoding device according to claim 1, wherein
a range settable as the group size is a fixed value or is calculated from another control signal or data.

9. The mesh decoding device according to claim 8, wherein
the range settable as the group size is a minimum natural number that is a power of 2 capable of covering the number of vertices of a base mesh in a case where the range is calculated from the other control signal or the data.

10. The mesh decoding device according to claim 1, wherein
the motion vector calculation unit sets the number of all vertices to the group size in a case where a predetermined flag is TRUE, and does not change the group size calculated from the control signal in a case where the predetermined flag is FALSE.

11. The mesh decoding device according to claim 1, wherein
the control signal is set for each sequence or each frame.

12. A mesh decoding method comprising:
a step A of generating a motion vector residual from a bit stream of an inter frame;
a step B of acquiring decoded motion vectors from a vertex to be decoded and surrounding vertices connected to the vertex to be decoded, and outputting a motion vector predicted value of the vertex to be decoded using all or some of the decoded motion vectors; and
a step C of outputting a motion vector of the vertex to be decoded, wherein
in the step C,
in a mode 1, the motion vector of the vertex to be decoded is output by adding the motion vector residual and the motion vector predicted value,
in a mode 0, the motion vector residual is output as the motion vector of the vertex to be decoded,
the same mode is set for motion vectors of N (N≥1) consecutive vertices in a decoding order,
the N vertices are included in one group, and
a control signal is decoded from a bit stream, the control signal being a signal for calculating a group size indicating a size of the group.

13. A non-transitory computer-readable medium having stored thereon a program that is executable by a computer to cause the computer to function as a mesh decoding device, the mesh decoding device comprising:
a motion vector residual decoding unit that generates a motion vector residual from a bit stream of an inter frame;
a motion vector prediction unit that acquires decoded motion vectors from a vertex to be decoded and surrounding vertices connected to the vertex to be decoded, and outputs a motion vector predicted value of the vertex to be decoded using all or some of the decoded motion vectors; and
a motion vector calculation unit that outputs a motion vector of the vertex to be decoded, wherein
in a mode 1, the motion vector calculation unit outputs the motion vector of the vertex to be decoded by adding the motion vector residual and the motion vector predicted value,
in a mode 0, the motion vector calculation unit outputs the motion vector residual as the motion vector of the vertex to be decoded,
the motion vector calculation unit sets the same mode for motion vectors of N (N≥1) consecutive vertices in a decoding order,
the N vertices are included in one group, and
the motion vector calculation unit decodes, from a bit stream, a control signal for calculating a group size indicating a size of the group.
